(19) United States
(12) Patent Application Publication
(10) Pub. No.: US 2026/0170241 A1
(43) Pub. Date: Jun. 18, 2026

(54) ELECTRONIC SYSTEM AND METHOD FOR PROVIDING SUGGESTED REVISED ELECTRONIC COMMUNICATIONS IN REAL TIME BASED ON A RECIPIENT COMMUNICATION STYLE

(71) Applicant: Xylo AI Corp, Minneapolis, MN (US)

(72) Inventors: David Barta, Brooklyn Park, MN (US); Zach Paul Gunderson, Lakeville, MN (US); Roger Lam, Franklin, WI (US); Georgios Kourogiorgas, Chorley (GB); Srikanth Tadepalli, Plano, TX (US); Marwan Sherri, Dayton, OH (US)

(73) Assignee: Xylo AI Corp, Minneapolis, MN (US)

(21) Appl. No.: 19/531,961

(22) Filed: Feb. 6, 2026

Related U.S. Application Data
(63) Continuation-in-part of application No. 18/793,556, filed on Aug. 2, 2024.
(60) Provisional application No. 63/530,390, filed on Aug. 2, 2023.

(51) Int. Cl. G06F 40/253; G06F 40/166

(52) U.S. Cl. CPC G06F 40/253; G06F 40/166

(57) ABSTRACT

Embodiments of the present disclosure relate to a system, software application, and methods for providing an improved electronic written communication that sounds like the user, as well as being tailor-fit to the writing style of the recipient in order to avoid miscommunication caused by personality, clarity, cultural, or generational writing differences. Systems and methods of the present disclosure may enhance written electronic communication through the integration of personalized profiles for both senders and recipients. By leveraging advanced stylometry and behavioral psychology profiling, the system tailors communications to fit individual needs. Additionally, this solution ensures that system-generated content matches the sender's natural writing style, saving time and maintaining authenticity. The system also provides real-time feedback and adjustments to avoid potential communication frictions. Moreover, embodiments of the present disclosure bridge miscommunication gaps caused by cultural and generational differences by interpreting these nuances and incorporating them into the improved electronic written communication.

### CROSS-REFERENCE TO RELATED APPLICATIONS

This application claims the benefit under 35 U.S.C § 119(e) of provisional application 63/530,390, entitled, “A System and Method for Providing Suggested Revised Language Based on a Recipient's Communication Style,” filed, Aug. 2, 2023, the entire contents of which is incorporated by reference herein in its entirety.

### TECHNICAL FIELD

The present disclosure in some embodiments relates to electronic, software and/or hardware-based systems and methods for providing in real time suggested changes to an electronic mail or other communication based upon the communication style of the intended recipient of the communication. In some embodiments, the present disclosure uses artificial intelligence and/or natural language processing to generate improved responses to electronic communications from a sender. More particularly, in some embodiments, the present disclosure includes targeting enhancements in written electronic communication through personalized profiling and emotional intelligence enrichment.

### BACKGROUND

Electronic communications, such as electronic mail, text, and/or chat or instant messaging are routinely used—by most people on a daily basis—both in the work environment and outside of the work environment. It is well understood that people have different communication styles, based on a variety of factors, including living location, age, upbringing, personality, life experience, etc. Psychologists, sociologists, and others have conducted extensive research to identify and categorize primary, secondary, et cetera communication styles that generally could apply to everybody. Many of the frameworks developed use four primary communication types. For example, four major communication styles have been modeled by DISC (DISC is an acronym with the first letter of each style—Dominance, Influence, Steadiness, and Conscientiousness). Further, Social Styles is another framework that categorizes communication styles into four types: Driving, Expressive, Amiable, and Analytical. While the two models use different terms to describe the four styles, the models generally correlate with one another. For example, Social Styles (SS) Driving=DISC Dominance; SS Expressive=DISC Influence; SS Amiable=DISC Steadiness; SS Analytical=DISC Conscientiousness. The two models present communication style information in some cases using a graph with an x-axis and y-axis. The two axes describe people/emotional-oriented attributes versus data/task-oriented attributes on one axis and tell/aggressive versus ask/passive on the other axis.

Miscommunication in emails is widespread, primarily due to the fact that written electronic communication does not occur face-to-face, which may severely impair the ability to pick up emotional and other important cues in a conversation. This problem is amplified in remote and hybrid work scenarios where face-to-face interactions are limited. The lack of tailored communication often leads to misunderstandings, reduced productivity, and strained professional relationships. Furthermore, cultural and generational differences, as well as language barriers among global teams may compound miscommunication issues. Most people do not have the time—and many people may not have the ability—to tailor each piece of writing to fit the recipient's communication style; nor are most people conscious of the personality or cultural differences that may necessitate updates to their written communication to avoid miscommunication.

The prevalence of remote, hybrid, and multi-location work environments has significantly increased the importance of effective written communication. Global teams often consist of individuals who are non-native English speakers, which can exacerbate misunderstandings. Traditional communication tools facilitate message exchange, but frequently fail to address individualized communication needs, resulting in generic and sometimes ineffective electronic interactions.

This problem is also present when the author does not know the recipient(s) of an electronic communication and has no way of knowing the recipient's communication type. For instance, a person working remotely may be communicating with co-workers he/she has never met. Businesses may lose money because of miscommunications in written communications between co-workers and third parties because the author does not craft the written communication to be consistent with the communication type of the recipient.

Thus, there is a need for systems and methods that can identify and categorize the communication type of a recipient of an electronic communication and automatically suggest modifications to a communication such as an e-mail based on the communication type of the recipient or primary recipient to improve electronic communication between people.

### SUMMARY OF THE INVENTION

In some embodiments of the present disclosure, the method includes providing an improved electronic communication, where the method includes receiving a plurality of sample electronic communications for a recipient and then determining via a style identification engine a communication profile for the recipient based on the plurality of sample electronic communications. The method also includes receiving an initial electronic communication from a user to the recipient and then revising the initial electronic communication via an improved response generation engine to produce a suggested improved electronic communication that better reflects the recipient's determined communication profile. The suggested improved electronic communication is then provided to the user.

The method may also include the step of determining the communication profile of the recipient includes sending the style identification engine explicit definitions for a plurality of communication styles that make up the communication profile. In some embodiments, the method may further include producing at least one action item for the user based on the initial or the improved electronic communication, and providing the at least one action item to the user.

In still other embodiments, the method includes producing at least one action item for the recipient based on the initial or the improved electronic communication and providing the at least one action item to the user.

In some embodiments, the method includes an initial electronic communication that includes a plurality of individual electronic communications.

In some embodiments, the method also includes providing to the user a summary of the initial electronic communication, wherein the summary is provided according to the determined communication profile of the recipient.

In some cases, the method includes providing on a user-interface of a computing device of the user the ability to accept, reject, or revise the improved electronic communication.

Some embodiments of the method further include, the plurality of sample electronic communications from the recipient numbering at least four.

The method may include the suggested improved electronic communication being for an entirety of the initial electronic communication.

In some embodiments of the method, the suggested improved electronic communication is for a portion of the initial electronic communication.

In some embodiments of the present disclosure, a system for providing an improved electronic communication that is tailored to a determined communication style of an intended recipient of the electronic communication is provided, where in the system includes: a database to store a plurality of sample communications from at least one user; a style identification engine, including software programmed such that when it is executed the style identification engine provides a determined communication style for each of the at least one user based on the stored plurality of sample communications of each of the at least one user, wherein the style identification engine includes a large language model module that receives explicit definitions for a plurality of communication types that make up the determined communication style; and an improved response generation engine, including software programmed such that when it is executed, the improved response generation engine provides the improved electronic communication that includes changes from an initial electronic communication where the changes are in the determined communication style of at least of the users that is the intended recipient of the improved electronic communication.

In some embodiments, the system also includes the user being an employee of a company, and wherein the initial electronic communication is a work-based communication.

The system may further include an administrative panel module that is accessible by an administrator of the company, the administrative panel module including at least one policy document provided by the administrator of the company for use by the improved response generation engine.

In some embodiments, the system may include the at least one policy document being a template that is used by the improved generation engine in providing the improved electronic communication.

In some embodiments, the at least one policy document includes at least one rule that is used by the improved generation engine to control a set of language that can be included in the improved electronic communication.

In some embodiments, the at least one rule prohibits the use of one or more words.

In some embodiments, the at least one rule defines at least one acronym.

The system according to some embodiments includes the improved generation engine providing to the user a summary of the improved electronic communication, and also provides at least one action item based on the initial electronic communication.

The system may further include where the summary and the at least one action item are provided in any chosen language.

In some embodiments, the system may further include a verify and correct engine that receives the improved electronic communication from the improved response generation engine, the verify and correct engine including software that when executed identifies further improvements that can be made to the improved electronic communication, where the further improvements are based on the determined communication style of the recipient.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 shows a screenshot illustrating various attributes of some embodiments of the present disclosure, as would be seen by a user of the system;

FIG. 2 illustrates a screenshot that summarizes an email thread and extracts action items from an email thread in one of several languages, according to some embodiments of the present disclosure;

FIG. 3 shows a block diagram of a system of the present disclosure, according to some embodiments of the present disclosure;

FIG. 4 shows a flow diagram of a method of the present disclosure, according to some embodiments;

FIG. 5 shows a screenshot of the system providing a user a revised email that better reflects the recipient's communication style, according to some embodiments of the present disclosure;

FIG. 6 shows a graphical comparison of providing the improved response generation engine with explicit definitions of communication styles versus not providing such definitions, according to some embodiments of the present disclosure;

FIG. 7 shows a graphical comparison of providing the improved response generation engine with variable versus fixed prompts, in accordance with some embodiments of the present disclosure.

FIG. 8 shows a screenshot of systems and methods of the present disclosure that provide insight into characteristics of a user's contacts and provides historical information as well, according to some embodiments.

FIG. 9 shows a screenshot of systems and methods of the present disclosure that provide templates for a user to aid in assisted and/or automated document creation, according to some embodiments.

FIGS. 10A and 10B show screenshots of systems and methods of the present disclosure that allow a user to define and/or provide rules for words or phrases to assist in communication creation, according to embodiments of the present disclosure.

FIG. 11 shows a screenshot of systems and methods of the present disclosure that allows a user to create a template to aid in communication creation, according to embodiments of the present disclosure.

FIG. 12 shows a behavior-aware communication environment, according to embodiments of the present disclosure.

FIG. 13 illustrates a behavioral-alignment graph and the operation of a miscommunication-risk score module, according to embodiments of the present disclosure.

FIG. 14 shows a messaging-guidance interface, according to embodiments of the present disclosure.

FIG. 15 shows a miscommunication-analytics interface, according to embodiments of the present disclosure.

FIG. 16 depicts a productivity-analytics dashboard, according to embodiments of the present disclosure.

FIG. 17 shows an insight report dashboard, according to embodiments of the present disclosure.

FIG. 18 shows a red-flag monitoring dashboard, according to embodiments of the present disclosure.

FIG. 19 shows a red-flag detection interface, according to embodiments of the present disclosure.

FIG. 20 shows a manager-coaching dashboard, according to embodiments of the present disclosure.

FIG. 21 shows an enhanced communication-generation architecture within an improved response-generation engine, according to embodiments of the present disclosure.

FIG. 22 shows an enhanced communication-generation architecture in which a personalized rewriter interface appears on the same dashboard that hosts a rewriter sub-module, according to embodiments of the present disclosure.

FIG. 23 shows a client-analytics architecture, according to embodiments of the present disclosure.

FIG. 24 shows a client-relationship analytics dashboard, according to embodiments of the present disclosure.

FIG. 25 shows a retrieval-augmented generation architecture 2500, according to embodiments of the present disclosure.

FIG. 26 shows a communication summarization and action-extraction architecture, according to embodiments of the present disclosure.

FIG. 27 shows an administrative rule-template architecture, according to embodiments of the present disclosure.

FIG. 28 shows a short-form-messaging architecture, according to embodiments of the present disclosure.

FIG. 29 shows a mobile-workflow architecture, according to embodiments of the present disclosure.

FIG. 30 shows an illustrative embodiment of a communication channel, according to embodiments of the present disclosure.

FIG. 31 shows an illustrative embodiment of a knowledge graph, according to some embodiments of the present disclosure.

### DETAILED DESCRIPTION

Embodiments of the present disclosure include systems and methods to improve electronic communication. More specifically, systems and methods of the present disclosure improve electronic communication by providing suggestions for improvements to electronic communication that better reflect the communication style of the recipient of the communication but are still in the style of the sender. In some embodiments, systems and methods of the present disclosure leverage the use of artificial intelligence (AI), machine learning, and/or natural language processing (NLP).

While embodiments may be described with references to electronic mail, or e-mail, it will be understood that systems and methods of the present disclosure may be used with any form of electronic communication, including, but not limited to text, chat, instant messaging, word processing document creation and exchange, and/or any other form of electronic communication. Further, while embodiments of the present disclosure may be described with reference to work-based communication, it will be understood that the present disclosure applies equally to other forms of electronic communication, such as personal communication, or any other communication between people who may not be co-works, but rather may be friends, family members, neighbors, members of an association, a service provider and customer, and/or any other type of electronic communication that may occur between two or more people.

Communication between people, including between co-workers, may be more effective if the message is written to comport with the communication style of the recipient. Typically, people do not always effectively craft electronic communication to take into account the communication type of a recipient. Systems and methods of the present disclosure include generating writing that sounds like the user, as well as tailor-fitting the writing to avoid miscommunication caused by personality, clarity, cultural, or generational writing differences, for example. According to some embodiments, systems and methods include enhancing written communication through the integration of personalized profiles for both senders and recipients. By leveraging advanced stylometry and behavioral psychology profiling, the system tailors communications to fit individual needs. Additionally, embodiments of the present disclosure ensure that AI-generated content matches the sender's natural writing style, saving time and maintaining authenticity. In some embodiments, the system may also provide real-time feedback and adjustments to avoid potential communication frictions. Moreover, systems and methods of the present disclosure may bridge miscommunication gaps caused by cultural and generational differences by interpreting cultural and generational-based nuances and incorporating them into the writing.

In some embodiments of the present disclosure, the inventive system can generate writing that sounds like the user, as well as tailor-fit the writing to avoid miscommunication caused by personality, clarity, cultural, or generational writing differences. Methods of the present disclosure may enhance electronic written communication through the integration of personalized profiles for both senders and recipients. By leveraging advanced stylometry and behavioral psychology profiling, the system may tailor communications to fit individual needs. Additionally, embodiments of this solution may ensure that AI-generated content matches the sender's natural writing style, saving time and maintaining authenticity. The system also provides real-time feedback and adjustments to avoid potential communication frictions. Moreover, systems and methods of the present disclosure may help bridge miscommunication gaps caused by cultural and generational differences by interpreting these nuances and incorporating them into the writing.

In some embodiments, systems and methods of the present disclosure include one or more of the following benefits over traditional electronic communication exchange: personalized communication that includes improved written communication by tailoring messages to the recipient's profile; style matching by generating content in the sender's style from brief descriptions, ensuring AI-generated text matches the sender's natural writing style; tailored responses by offering full tailored email responses within a reply chain; feedback and nudges providing recipient-unique feedback on tone, clarity, politeness, and personalization, and nudge rewrites to avoid communication frictions; enhanced summarization that summarize email threads and extract actionable items; administrative management that allows the administrator to manage company-specific documentation through an administrative panel; meeting scheduling that automatically recognizes the need to schedule meetings based on email content and provides scheduling capabilities; cross-platform functionality that supports the use across various communication clients such as Outlook, Gmail, Slack, and Teams, for example; privacy preservation that extracts and uses certain traits for emotional intelligence enhancement without storing any customer email content; team collaboration that includes enhanced draft and rewrite functions through team-shared documents, enabling quick retrieval of accurate product information; and/or custom templates with specific documents for consistent and efficient email drafting.

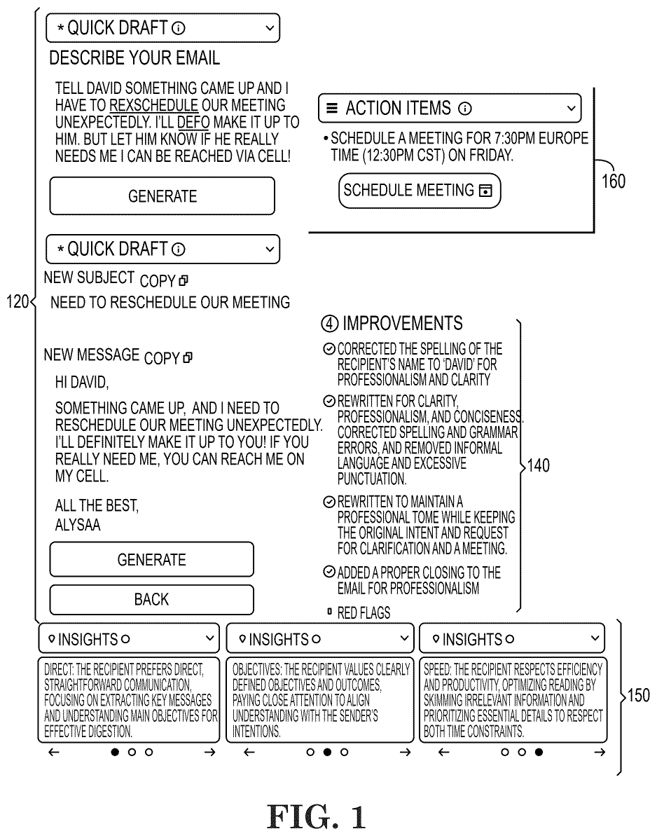

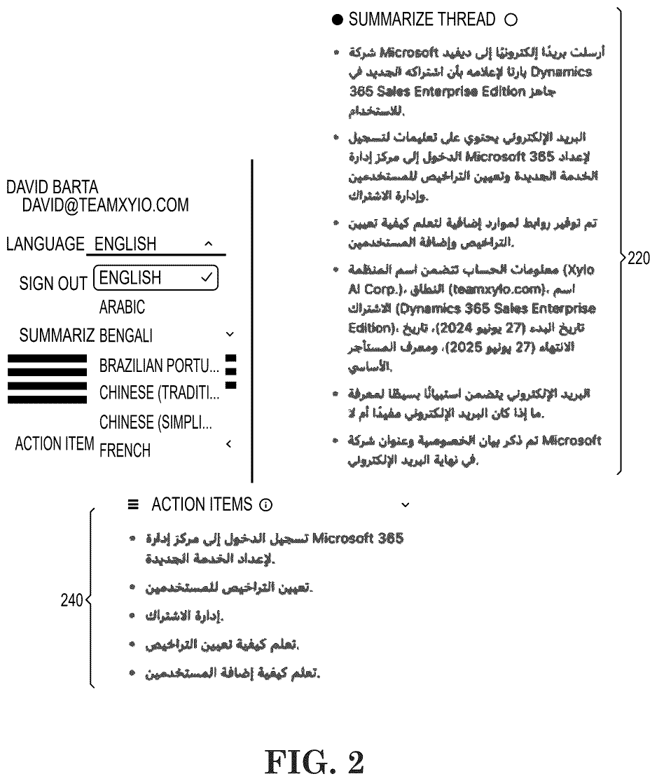

Systems and methods of the present disclosure in some embodiments may include, or may also include, one or more of the following features as shown with reference to FIG. 1: Email Rewriting: the system may rewrite email drafts 120 to better tailor them to the recipient's profile 150. This may include adjusting the tone, style, and content to ensure clarity and appropriateness 140; Style Matching: the system may generate full tailored emails in the sender's style from brief descriptions 120. By leveraging user-specific stylometry, the generated content may closely match the natural writing style of the sender, ensuring authenticity; Stylometry-Based Writing: in some embodiments the system uses an advanced stylometry and natural language processing (NLP) process to ensure artificial intelligence (AI)-generated content that matches the sender's natural writing style, saving time and enhancing authenticity; Communication Style Management: the system in some embodiments stores different personal styles such as professional and casual, auto-generates these styles, and allows for fine-tuning by the user. This feature helps users maintain consistency in their communication; Reply Chain Tailoring: provides full tailored email responses within a reply chain, taking into account the context and previous exchanges to ensure coherence and relevance; Feedback and Suggestions: offers recipient-specific feedback and suggestions on tone, clarity, politeness, and personalization 140, 150. Additionally, the system may provide nudges and suggestions for rewrites to avoid potential communication frictions; To-Do Extraction: automatically extracts actionable items from email threads, helping users keep track of tasks and follow-ups efficiently; Meeting Scheduling: recognizes the need to schedule meetings based on email content and provides the user with quick scheduling options, streamlining the process 160; Cross-Platform Functionality: supports use across multiple email clients, for example, with Outlook and Gmail, ensuring consistent user experience regardless of the platform used; Nudging for Communication Efficiency: detects potential communication frictions based on personality, cultural, and generational differences, providing nudges and rewrite suggestions to avoid these frictions and enhance communication efficiency; Privacy-Preserving Data Extraction: the system may extract and utilize only the necessary traits for emotional intelligence enhancement without storing any customer email content. This approach ensures user privacy and data security; Team Document Sharing for Retrieval-Augmented Generation (RAG): utilized shared documents within teams to enhance the draft and rewrite functions. By retrieving accurate product or company-specific information mentioned in emails, the system reduces repetitive detail inputs, ensuring efficient communication; Custom Templates: allows users to create and use custom templates in conjunction with specific documents to streamline email writing and maintain consistency across communications; Multilingual Summarization: summarizes email threads in multiple languages, providing concise overviews 240 and extracting actionable items 220, as shown in FIG. 2. This is particularly useful for global teams that deal with emails in various languages.

Generally, according to some embodiments, systems and methods of the present disclosure may review and analyze sample communications, such as five or more electronic communications from an individual to determine a communication type or style for the individual. In the work environment, this methodology may be used to determine the communication type of each employee, for example, or in other cases, some subset of employees. Over time, the system may continue to analyze communications of each user/employee to refine the communication type for each individual.

Then, in one embodiment, based on the communication type of recipient or primary recipient as determined by the system, the system recommends modifications to a draft communication to make it more consistent with the communication style of the recipient or primary recipient's determined communication style. For instance, when an employee writes an email to a certain email address (e.g., bob@work.com), the system reviews the draft to Bob, and based on Bob's communication type as determined by the system, the system suggests modification to the draft e-mail that models Bob's communication style. The result of the review is that before the employee hits “send,” the employee's email to Bob is rewritten by the system to match Bob's communication style, enabling Bob to better understand the received communication.

The present invention may be used with any written electronic communication, not just e-mails. Further, a person's communication style can be different based on the written communication form. Systems and methods of the present disclosure may include multiple communication styles and sub-styles based on the form of communication utilized, for example, text/chat (over Slack or Teams, for example) versus email (over Outlook or Gmail, for example) and then provide suggested modifications to the author based on the communication form and type of the recipient.

In one embodiment of the present disclosure, the system determines the communication style of an individual or a group of individuals, for example each employee in a company, or each member in a family by using electronic communication samples, for example e-mails. For example, in the work context, the system determines each employee's communication type based on prior written electronic communications. In one embodiment, an employee's communication type is determined with prior written samples used in the communication mode. For instance, in one embodiment, for e-mail communications, a user's prior e-mails are used to determine the user's communication type. Because people fall into different communication types, in one embodiment, the system includes a profiling method that places each person in one of four quadrants of communication types, for example. In one embodiment, the system uses the following four communication types: 1) Data-Ask style, the 2) Data-Tell style, the 3) People-Ask style, and 4) the People-Tell style. In other embodiments, the system profiles individuals based on ask/tell and emotive/control frameworks. In one embodiment, the system analyzes a person along two continuums, the assertiveness (one end would be ask/passive, the other end tell/aggressive) and the emotive (one end would be task/controlled emotions, the other side would be emotional/expressive/people/relationship oriented). In still other embodiments, the system profiles individuals based on other known or later arising categories of communication style.

Systems of the present disclosure may use stylometry to assess an individual's communication style and/or provide suggested improvements to an electronic communication. Specifically, systems may include using NLP to analyze and store unique writing patterns, structures, and styles of users in vectors and metadata. The system may also include a machine learning engine that may include public and/or proprietary information and methods and may learn and store communication, and in some embodiments may also store behavioral psychology profiles of users. The system may further include one or more databases for storing different personal styles such as professional and casual styles. The system may provide suggested improvements to a communication based on matching the communication style of a recipient and stored writing patterns for a particular communication style, thereby allowing a sender to accept or deny a given suggestion and/or fine tune a suggested improvement. The suggested improvements are provided seamlessly and in substantially real-time.

In some embodiments, the system may include a modular, end-to-end series of engines that may employ artificial intelligence and/or a large language model-that may, for example, process multi-modal communication data, extract behavioral and linguistic insights, and deliver structured outputs to front-end analytics dashboards or integrated applications. The systemnormalize and/or parse the input stream(s) into structured text segments suitable for downstream analysis.

In some embodiments, the input data may be transmitted to a series of discrete, task-specific agents or modules. These agents or modules may include, for example, Large Language Models, other language models, and/or AI engines. By way of non-limiting example the agents may include: (i) a sentiment agent that may score language on a sentiment continuum using a fine-tuned transformer model and/or may execute additional analysis; (ii) a style agent that may extract tone, formality, and structural features and/or additional features of written communication; and/or (iii) one or more behavioral agents that may infer behavioral attributes of the sender based on one or more behavioral modes, for example, but not limited to the Five-Factor Personality Model (i.e., openness, conscientiousness, extraversion, agreeableness, and neuroticism). Of course, additional and/or different agents may also be employed by the system, as discussed further herein. It will be understood that the names provided for engines, modules, agents, etc. are not limiting or determinative of their respective use within a disclosed embodiment. The one or more agents may receive the input, extract analytic inputs from the input and perform one or more series of analysis on the extracted analytic inputs to provide one more outputs. Each agent may operate independently or as part of an orchestrated pipeline, depending on the deployment context and computational constraints.

The one or more outputs generated by the one or more agents may be stored in a centralized or distributed output database in a structured format, in some embodiments. Output schemas may include, but not be limited to GraphQL, JSON, and/or XML for example, which may facilitate flexible integration with external systems such as dashboards, CRMs, human capital management platforms, and/or business intelligence tools. Downstream presentation logic may render these structured outputs within system graphical interfaces, including but not limited to sentiment trend visualizations, personality assessments, miscommunication risk maps, and/or churn risk alerts to name a few.

In one embodiment, the system may include optional data anonymization and role-based access control layers to ensure compliance with enterprise data privacy requirements or other privacy requirements.

In some embodiments, the system may be designed for secure and flexible deployment across diverse enterprise environments, offering customers a choice between a fully managed and system-hosted configuration and a customer-hosted deployment model, commonly referred to as “Bring Your Own Host” (BYOH), while it will be understood that other and/or different deployment models (e.g., hybrid or multi-tenant variations) may be supported in additional embodiments. This deployment flexibility may enable organizations to align the system with their existing IT infrastructure, regulatory obligations, and/or data governance policies, for example.

In the system-hosted configuration, all processing, including data acquisition, language-model execution by the modular agents, and dashboard rendering via the presentation-layer interface may be performed on one or more secure servers managed by the system provider. In the BYOH model, core components of the system, including for example, the scanner API, modular agents, and/or output databases, may be deployed within the customer's own infrastructure (e.g., on-premises server(s) or private-cloud instances). Of course, a mix of hosted deployments may also be used. In any configuration, in some embodiments, communications between modules may be encrypted using industry-standard protocols such as TLS or HTTPS, and system access may be controlled via role-based authentication mechanisms: though other or different encryption or authentication schemes may be used in alternative embodiments.

In some embodiments, the system may be designed to operate without storing or training on any user-generated communication data. Some or all analyzed content, whether internal email, chat, CRM entries, or other may be processed in-memory or via ephemeral data stores that may be purged upon completion of the analytical cycle, or at another time or other point. In some embodiments, limited or no customer messages may be persisted beyond the immediate session, and limited or no data may be used to further train the system's underlying large language models. This “zero storage, zero training” approach used in some embodiments may ensure compliance with enterprise-grade data privacy requirements, including but not limited to GDPR, CCPA, and HIPAA where applicable.

Additionally, the system may include a modular or other plugin ecosystem that enables seamless integration with widely used enterprise communication platforms. Supported plugins may include, without limitation: Microsoft Outlook, Gmail, Slack, Microsoft Teams, Salesforce, HubSpot, and Copilot. These integrations may allow users to access system functionality (e.g., real-time sentiment feedback, rewrite suggestions, behavioral insights) directly within their preferred tools, without requiring context-switching or manual data export.

In some embodiments, the system may include mobile-first workflows designed to optimize digital communication tasks for users operating on smartphones, tablets, and/or other portable and/or wearable computing devices. In some embodiments, Workflows may be accessible through a mobile-optimized web interface hosted by the system, which may provide access to some or all of the system's full suite of drafting and editing functionalities without requiring a dedicated application download or desktop environment.

In some embodiments, the mobile and/or web interface may include voice-to-text transcription and in some cases real-time voice-to-text transcription, allowing users to dictate written messages using their device's built-in microphone. In some embodiments, transcribed content may be captured by a speech recognition module and be seamlessly routed to a rewriter engine, which may generate polished drafts suitable for immediate use, in some embodiments. In one embodiment, transcription may be initiated via a single-tap, for example, though of course other initiation methods may be used. The system may also include the ability for users to receive and/or apply stylistic adjustments provided by the system, and/or return a completed email draft within seconds. Each of these functions in some embodiments may be performed using a single-tap methodology, or other fast and intuitive method. In some embodiments, the workflow may be designed to accommodate both short-form (e.g., chat-style) and long-form (e.g., email-style) communications.

In some embodiments, the mobile interface may also allow users to access a system-generated personalized tone model, adjust voice settings, or preview rewritten drafts in multiple style variants before copying or exporting the final version. Such a workflow may be particularly beneficial for users who benefit from high-quality, low-effort messaging while traveling, working remotely, or multitasking, for example. In some embodiments, the system may include a clipboard export feature, enabling users to copy the generated message and paste it into native mobile email or messaging clients such as Gmail, Outlook, SMS and/or other platforms.

Performance optimizations in the mobile interface in some embodiments may include predictive caching of language model queries, adaptive UI components based on screen size, and/or latency-aware streaming of draft previews, for example. Additional or alternative performance-optimization techniques may be utilized in other embodiments. Together, these elements may facilitate a highly responsive, frictionless mobile authoring experience that may reduce and/or significantly reduce the time and/or cognitive load associated with communication on the go.

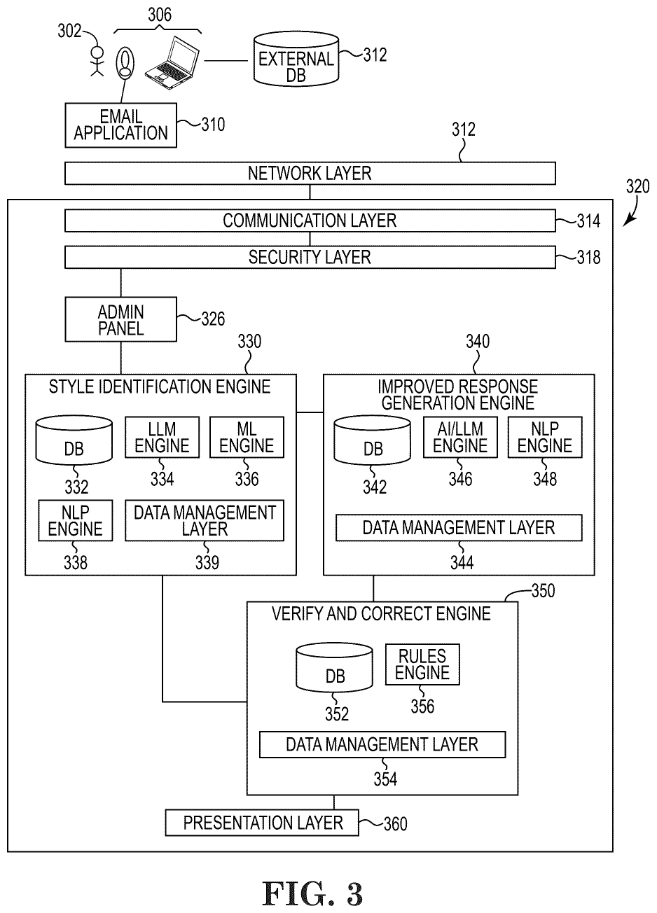

FIG. 3 shows a diagram of a system of the present disclosure according to some embodiments. As may be seen, a user may use a computing device 306, for example a computer, cell phone, tablet, etc. to access a communication program 310, such as an email program that may have access to an external database 312 that may store saved electronic communications, such as e-mails, for example. The communication program 310 may include a system application controller within it or the user 302 may download an application to use in conjunction with the communication program. The computing device 306 may be in communication with the improved communication system 320 via a communication layer 314 over a network 312. An administrative interface may be accessed through the administrative panel 326 by a user or a user's designated or appointed and authorized administrator, such as an employer administrator. Sample communications for a user or users that may be stored in an external database 312 for example may be forwarded to the style identification engine 330 of the improved communication system 320. A security layer 318 ensures that the system 320 does not retain any information from the sample communications that is not necessary, and/or that is protected, confidential, or otherwise should not be provided or accessible by the system after the style identification engine 330 uses the content to determine the communication style of a user. The style identification engine 330 may use a number of modules to determine the communication style of a user from the sample communications provided to the engine 330. For example, the engine 330 may include one or more databases 332 for storing, or temporarily storing, sample communications, and/or communication style information, etc., along with a data management layer 339 that helps facilitate data movement through one or more modules of the engine 330. The engine 330 may include a large language model module 334, a machine learning engine module 336, and/or a natural language processing engine module 338, which are each discussed in more detail herein. The engine, through the use of the modules, provides a communication profile for a user that may be stored in a database 332 that is then sent to or accessed by the improved response generator engine 340 that may provide an initial communication or improved communication based on a recipient's communication profile and in response to a prompt from a user 302 or the system 320. The improved response generator engine 340 may include one or more databases 342 and a data management layer 344, in addition to one or more modules, including but not limited to an AI engine 346 that may incorporate therein an LLM module, and/or a NLP engine 348. In some embodiments, the output of the improved response generator engine 340, which may be an entire improved communication, and/or portions of an improved communication, may then be sent to or accessed by the Verify and Correct Engine 350, which may review and correct, and/or improve the output from the Improved Response Generator Engine 340. The Verify and Correct Engine 350 may include one or more databases 352 and a data management layer 354, along with at least one rules engine 356 that includes one or more sets of rules for ensuring that the improved communication is in line with the recipient's communication style, and/or is in compliance with a company's policies regarding electronic communications or other polices, for example. The results of the Verify and Correct Engine 350 may then be sent or accessed by the presentation layer 360 which may format and prepare the results for the user 302, and which then may be accessed by the user 302 via their communication device 306.

The term “code” or “algorithm” can include software or firmware. It can refer to one or more programs, routines, functions, and/or objects. Some or all code from multiple modules or engines can be stored by a single shared memory. The apparatuses, methods, and systems described herein can be implemented by one or more computer programs executed by one or more processors. The computer programs may include processor-executable instructions that may be stored on a non-transitory, tangible, computer-readable medium. The computer programs can also include stored data. Examples of non-transitory, tangible, computer-readable medium, include but are not limited to nonvolatile memory, magnetic storage, and optical storage.

The terms “database” or “storage device or engine” as used herein refer to either a body of data, a relational database management system (RDBMS), or both. A database or storage engine may comprise any collection of data including hierarchical databases, relational databases, flat file databases, and any other structured collection of records or data that may be stored in a computing system, including but not limited to Oracle, MYSQL, IBM, DB2, SQL Server, POSTGRESQL, Microsoft, SYBASE, or any other database that enables the systems and methods described herein.

The hardware layer of the system can include one or more central processing units (CPUs), memory controllers, and other devices, components, or elements of a computer system such as volatile or nonvolatile memory, nonvolatile storage, including disk and I/O devices or interfaces. This layer may further include programmed instructions that support virtualization, containerization, or other technologies.

With continued reference to FIG. 3, the computer system of the present disclosure 320 may use one or more computing devices 306, including mobile computing devices. Note that embodiments of systems of the present disclosure may include each component disclosed regardless of whether each component is shown in FIG. 3 or other figures, and similarly may include components configured in alternate disclosed configurations than those shown in FIG. 3. The system and/or external data server(s) may be implemented using two or more processors, cores, clusters, or instances of physical machines or virtual machines configured in a discrete location or co-located with other elements in a datacenter, shared computing facility or cloud computing facility. In some embodiments, the external data server may be incorporated within the system.

The implementation of the functions described in the present disclosure using one or more computer programs or software elements that are loaded into and executed using one or more general purpose computers may cause the general-purpose computer(s) to be configured as a particular machine or as a computer that is specially adapted to perform the functions described herein.

In some embodiments, the system may be available on a mobile application or “app” that includes an integrated software platform or controller. Instructions in the main memory of the computer system may be enacted when the app is loaded for execution. The instructions can be stored in, for example, RAM or other main memory, or one or more blocks of disk storage or other non-volatile storage. In one embodiment, the app comprises, for example, instructions for receiving, translating, and ingesting input data via manual upload, external application programming interfaces (APIs) that push data to the app, or instructions that call APIs of external systems to pull data into the app.

In one or more embodiments, the methods and systems can be implemented by one or more special-purpose computer devices. They may be hard-wired to perform the methods or may include digital electronic devices such as one or more application-specific integrated circuits (ASICs) or field programmable arrays (FPGAs) that are persistently programmed to perform the methods, and/or may include one or more general purpose hardware processors programmed to perform the methods according to program instructions in firmware, memory, other storage, or a combination thereof. Such special-purpose computing devices may also combine hardwired logic, ASICs or FPGAs with custom programming to accomplish the methods. The special-purpose computing devices may be desktop computer systems, portable computer systems, handheld devices, networking devices or any other device that incorporates hard-wired and/or program logic to implement the methods.

The computing device may include a bus or other communication mechanism for communicating information, a hardware processor coupled with the bus for processing information, a main memory, such as RAM or other dynamic storage device coupled to the bus for storing information and instructions to be executed by the processor, a read-only memory (ROM) or other static storage device coupled to the bus for storing static information and instructions for the processor, and/or a storage device, for example a magnetic disk, optical disk, or SSD coupled to the bus for storing information and instructions.

In some embodiments, the computing device may also include a display, such as a monitor to display information to a computer user, and/or an input device, such as keypad, mouse, etc. coupled to the bus for communicating information and command selections to the processor.

The computing device may also include hardwired logic, one or more ASICs or FPGAs, firmware and/or program logic to implement the methods of the present disclosure that in combination with the computer system causes or programs the entire system to be a special-purpose machine.

In some embodiments, the system may include performing methods by the system in response to the processor executing one or more sequences of one or more instructions contained in the main memory. Such instructions may be read into the main memory from another storage medium, such as a storage device.

Execution of the instructions in the main memory causes the processor to perform the process steps disclosed herein. In other embodiments, hardwired circuitry may be used in place of or in combination with software instructions.

The system may also include a communication interface 314 coupled to the bus. The communication interface may provide a two-way data communication coupling to a network, network link 312 that is connected to a local network, for example, the communication interface 314 may be an integrated services digital network (ISDN) card, cable modem, satellite modem, or a modem to provide a data communication connection to a corresponding type of telephone line. As another example, a communication interface may be a local area network (LAN) card to provide a data communication connection to a compatible LAN. Wireless links may also be used. In any such use, the communication interface may send and receive electrical, electromagnetic or optical signals that carry digital data streams representing various types of information.

A network link 312 may provide data communication through one or more networks to other data devices. For example, a network link may provide a connection through local network(s) to a host computer or to data equipment operated by an Internet Service Provider (ISP). The ISP in turn may provide data communication services through the Internet. Local network and Internet both may use electrical, electromagnetic or optical signals that carry digital data streams. The signals through the various networks and the signals on network link and through communication interface, which carry the digital data to and from the system are example forms of transmission media.

The system may send messages and receive data, including program code through the network(s), network link 312 and communication interface 314. The received code may be executed by the processor as it is received, and/or stored in the storage device, or other non-volatile storage for later execution.

In some embodiments, the system architecture may include deploying the application on Kubernetes clusters, for example, with globally scalable containers and in some embodiments, it may also be deployed on dedicated Virtual Machines (VMs). The backend APIs of the system may be hosted within these containers, which may securely interface with Large Language Model (LLM) endpoints, such as those provided by Azure OpenAI services, for example. The system, in some embodiments, may be designed to be LLM-agnostic, allowing seamless upgrades or other models as they become available or to specific domain models tailored for areas like healthcare, law, or finance based on user requirements, for example.

In some embodiments, the system may incorporate a Machine Learning (ML) pipeline that manages its ML models through distributed cloud-based, load-balanced infrastructure. The approach of Retrieval-Augmented Generation (RAG) may be applied by storing user document embeddings in a vector database in some embodiments. Elasticsearch may then be utilized to retrieve the most relevant data during AI text generation, according to some embodiments.

In some embodiment of systems and methods of the present disclosure, a mobile application may interact with the system API to facilitate on-the-go task completion. For instance, the application can quickly generate email replies that sound like the user by processing just a few bullet points, in some embodiments. By leveraging speech-to-text integration with the system API, in some embodiments users can verbally input their main points, allowing the application to generate a professionally written email with the right context. Additionally, with the system's summary API, the application can provide email summaries via AI-generated text-to-speech, which the user can listen to while on the move, with options to select the preferred language.

In another embodiment, a web application may use the system API and user data to provide a daily summary view, for example. This daily summary in some embodiments, may include personalized analyses, prioritized based on the user's needs via the summary API. In some embodiments, the application can extract actionable items from new emails, summarizing and prioritizing them for quick access, allowing users to easily identify emails that need immediate attention.

In one embodiment, a web application may interact with the system API and user data to scale professional communication authentically for social media posts. This application can plan and generate authentic-sounding posts, which can then be scheduled for posting on platforms such as LinkedIn. This ensures consistency and scaling of communication efforts across various social media platforms.

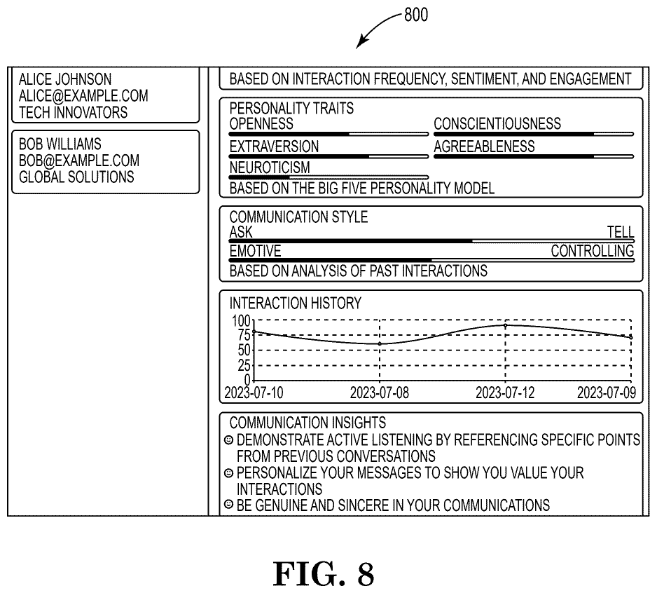

In another embodiment, a web application may pull data from multiple communication sources (e.g., Outlook, Gmail, Slack, and LinkedIn) and utilize the system API to analyze these communications. As may be seen in FIG. 8, the application may provide users with insights into the behavioral psychology of a user's contacts and recommend effective communication strategies for communicating with those contacts 800. The system may also analyze engagement over time, offering recommendations for optimizing communication based on past interactions 800.

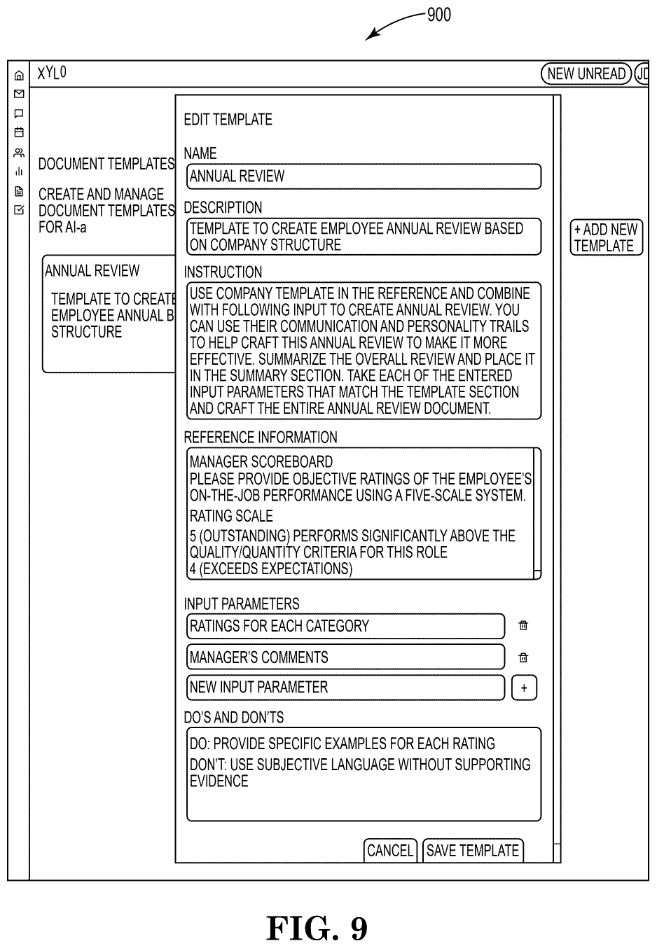

In one embodiment, a web application integrates with the system API and user data to create templates and automate document generation, as is shown in FIG. 9. For example, it can generate annual employee reviews that sound authentically like the user while ensuring the content is personalized and more likely to be well-received by employees 900. This application may streamline the document creation process, ensuring consistency and personalization in all generated texts.

In one embodiment, connecting the system API to short-form communication applications such as Slack, Microsoft Teams, and Twitter, for example may allow for real-time analysis of individuals the user is communicating with. This integration can generate warnings, suggestions, and corrections for example, on the fly, aiding the user in becoming a more effective communicator and reducing communication friction. For example, the API can analyze the tone and sentiment of messages in real-time, providing the user with prompts to adjust their language for better communication outcomes. Templates to generate user specific context for these short form communications may be able to integrate with the system API to generate common answers and replies that are detailed and professional, in some embodiments.

In another embodiment, integrating the system API with AI bots can significantly enhance the naturalness and adaptability of bot-generated text. This integration may allow the AI bots to modify their tone and style dynamically based on the recipient of the communication. This capability is particularly beneficial in scenarios such as customer service and Q&A, where chatbots are extensively used. For instance, an AI bot interacting with a frustrated customer can adopt a more empathetic tone, whereas a bot handling a straightforward inquiry can maintain a professional and concise style.

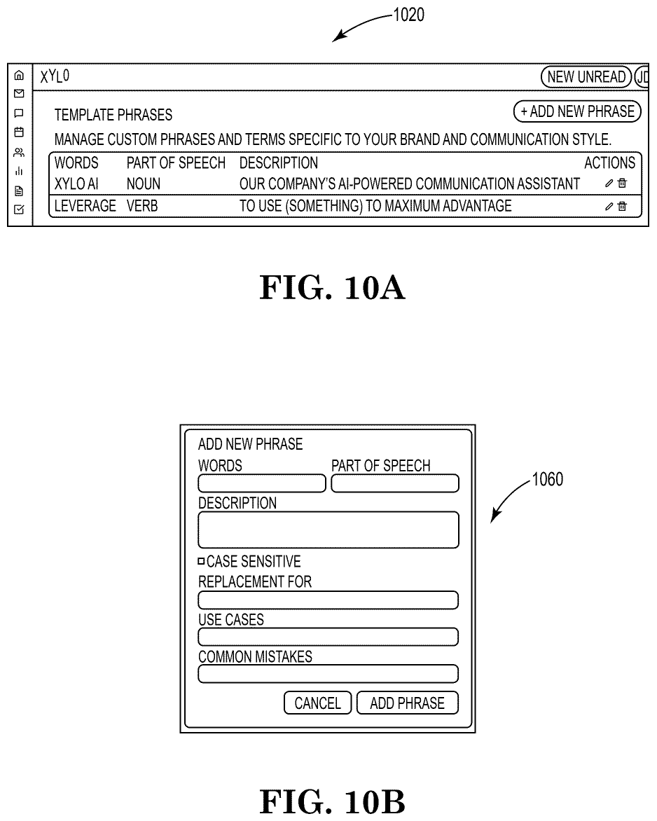

In one embodiment, the application may integrate with the system API to assist brands and writers by managing “Phrases” with specific rules that can be entered and shared within teams 1040, as may be seen in FIGS. 10A and 10B. These rules may guide AI-generated text to avoid common mistakes and ensure adherence to the company's brand guidelines. For example, rules can enforce correct capitalization of company or product names, ensure the confidentiality of sensitive customer or project names, and prevent their accidental disclosure 1020. This functionality can be pivotal in upholding the company's branding consistency and mitigating risks associated with inappropriate information sharing. The application can provide customized Red-Flag warnings to users as they compose messages, alerting them if they deviate from established brand rules or use restricted phrases.

In one embodiment, Customer Relationship Management (CRMs) may integrate with the system API to utilize one or more core ML inferencing models to enhance personal and effective engagements by leveraging behavioral psychology insights by sending data from the CRM, such as Salesforce, for example, to the system API. Through webapp or a separate CRM panel, for example, users can access individual psychology profiles and communication improvement recommendations that may provide a deep understanding of each contact's communication style, leading to more meaningful and impactful interactions.

Training in the Flow of Work: In some embodiments, the system integrates gamification and real-time feedback to provide continuous training in communication skills. Users may receive instant feedback on their communication effectiveness across various channels, helping them improve over time. This may be integrated with an API connection to one or more system Machine Learning Inferencing Models. For example, emails written that match a recipient's style may be given a higher score, and application users may challenge themselves to get a higher score without needing application assistance.

Sales Automation with Behavioral Insights: In another embodiment, the system may use behavioral psychology to provide communication insight for individual contacts, increasing the effectiveness of sales communications. This may be integrated into Sales Engagement Platforms and other similar programs via the API to power their core functionality with insights powered by the system Machine Learning Inferencing Models.

Customer Feedback Analysis: In another embodiment, customer feedback that may be either from email, website form submission, or other written documents may be analyzed. The system may provide nuanced communication insights and recommendations for improving customer satisfaction and engagement. Integration may be achieved via API or web application to the system Machine Learning Inferencing Models.

Improve new employee communication: In another embodiment, the system may use existing communication models and branding templates shared within the organization to improve the onboarding speed of individuals. New users, instead of having to learn to adapt to copy Acronyms, branding style, and specific user communication preference, can come in and already write in a level much more adapted to the organization.

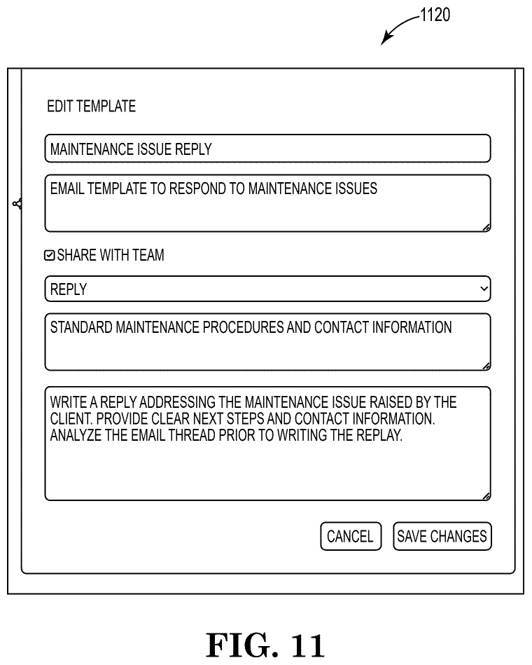

Customer Support Enhancement: In another embodiment, the system can integrate with customer support platforms, the system can use behavioral insights to tailor responses, as well as company specific documents such as product manual, repair guides, and detail support documents. The system may allow users to create specific documents and email reply templates 1120 to avoid problematic or inaccurate replies to customers, as may be seen in FIG. 11.

Personalized Leadership Communication: In some embodiments, the system may assist leaders in crafting department or company memos tailored to different groups. The system may use sentiment analysis and psychological profiles, for example to enhance the effectiveness and reception of communications. Integration may be achieved via API to the system Machine Learning Inferencing Models.

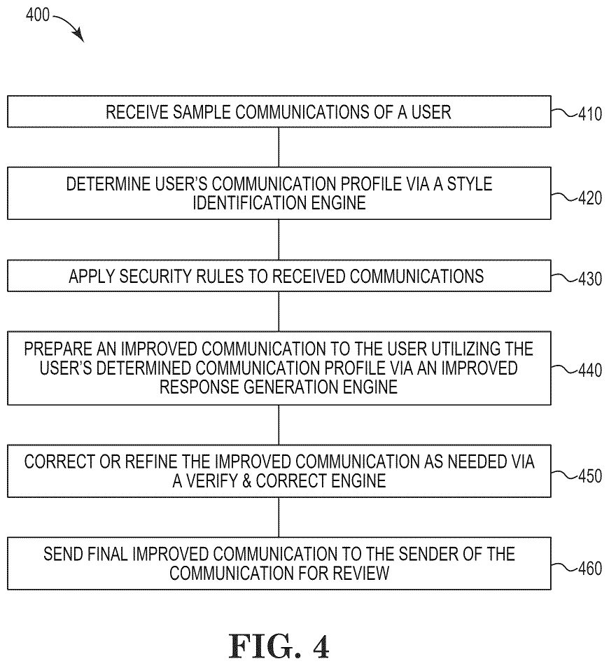

Behavioral Psychology Modeling. A method of the present disclosure 400 may include, with reference to FIG. 4, receiving samples of user's electronic communications 410 and determining the user's communication profile via a style identification engine 420. Security rules may be applied to the received sample communications 430 to ensure that no information is improperly retained. Using the communication profile of the user, preparing an improved communication to the user based on the user's communication profile determined at step 420, whereby the improved communication is determined via an improved response generation engine 440. In some embodiments, the improved communication is corrected or refined by a verify and correct engine 450 prior to being sent to the sender of the communication to the user 460.

As discussed above, a large repertoire of work exists and has existed for decades relating to assessing and defining different personality types and/or communication styles, etc. In one framework, a person may be assessed and defined according to an ask/tell and emotive/control framework, which may be used in some systems and methods of the present disclosure. The ask v. tell continuum may be expressed as an assertiveness continuum that may encompass a spectrum of communication styles. At one end is “asking,” where individuals use polite language and seek consensus. On the opposite end lies “telling,” characterized by direct instructions and prioritization of efficiency. Effective communication dances between these two approaches, adjusting steps based on context and relationships.

Individual communications can be scored on the Ask/Tell continuum (for concreteness, 0 is extreme Ask, 100 is extreme Tell, and 50 is the midpoint), which can be combined to get a person's overall score. If a certain threshold of difference exists between sender and recipient, nudging would be used.

Individual communications can be scored on the emotive/control continuum (for concreteness, 0 is extreme Emotive, 100 is extreme Control, and 50 is the midpoint). If a certain threshold of difference exists between sender and recipient, nudging would be used.

In some embodiments, the style identification engine may profile users based on five key traits, though it will be understood that embodiments of the present disclosure may include identifying and categorizing people according to any known or later-arising framework. In embodiments that use five key traits, users may be profiled based on Openness, Conscientiousness, Extraversion, Agreeableness, and Neuroticism. Systems and methods of the present disclosure may create a profile by using the sample quantity of electronic communications. The system may analyze each sentence of an email and score it on these five axes using regression models trained by the inventive system. In some embodiments, sentences in an email may be scored and then aggregated at the email level.

In the framework discussed including five key traits, the traits may refer to the following: Openness to Experience—describes an individual's imagination and creativity, intellectual curiosity, and willingness to try new things. Proving behaviors include enjoying learning, having an active imagination, being creative, and thinking about abstract concepts. Disproving behaviors include disliking change, sticking to routines, and being more grounded.

Conscientiousness—refers to how thoughtful and goal-oriented an individual is, their control over impulses, organization, and work ethic. Proving behaviors include being optimistic, emotionally stable, well-organized, hardworking, detailed-oriented, good at planning, and mindful of deadlines. Disproving behaviors include being impulsive, having trouble focusing, being messy, and prone to procrastination.

Agreeableness—describes how an individual treats relationships with others—kindness, helpfulness, and valuing social harmony. Proving behaviors include being altruistic, empathetic, caring, compassionate, and trustworthy. Disproving behaviors involve being selfish, stubborn, competitive, manipulative, and suspicious.

Neuroticism—refers to a person's emotional stability and unsettling thoughts or moodiness. Proving behaviors include often feeling insecure, getting stressed easily, being irritable, and experiencing mood swings. Disproving behaviors include being optimistic, managing stress easily, and feeling relaxed.

Extraversion—reflects how a person interacts socially, their emotional expression, and comfort in their environment. Proving behaviors include being outgoing, talkative, thriving in social situations, enjoying being around people, and seeking excitement. Disproving behaviors include being introverted, preferring solitude, feeling tired after socializing, and preferring smaller groups.

To profile these traits, the profile identification engine may score each sentence in an email on the respective axis using regression models trained on synthetic data. The scoring process captures nuanced behavioral traits that contribute to the overall persona depicted in the electronic communication exchange.

In embodiments of the present disclosure, nudging may be used to help a sender communicate more effectively with a person of a given communication style. For example, a suggested email to a person who is an “ask” communication style on the continuum may read, “Hi David!I was wondering, if you have some free time today, if you could please give me the form I am missing. it would be really helpful for me to have. Can you please send it to me, if you're not busy? Thanks, Bill.” In contrast, a suggested communication to a person (a nudge that the application provides) that is more “tell,” may be provided by the system, such as, “Hi David, I need the missing form today. Please send it to me as soon as possible. Thanks, Bill.” As may be seen, the “asks” have turned to “telling.”

The emotive versus control continuum encompasses contrasting communication styles. On one end, emotive communicators openly express emotions, thrive on spontaneity, enthusiasm, and persuasion. Conversely, the control communication style appears composed but subtly asserts authority through indirect cues, prioritizing goals over feelings. An example according to systems and methods of the present disclosure may include a nudge to a sender of an email that has been determined to be more towards the emote end of the continuum that reads: “Hi David, I hope you're having a great day!I'm really in need of the missing form today. It would mean a lot to me if you could send it over as soon as you can. Thanks so much, Bill.” In contrast, if a sender is writing to someone who is more toward the control end of the continuum, a potential nudge of the email above may be, “Hi David, I need the missing form today. Please send it to me as soon as possible. Thank you, Bill”. Note that in the control version of the email, the emotiveness is gone.

Systems and methods to create training data and ML model creation, according to some embodiments. Data used in training behavior psychology models may be a mixture of synthetically labeled text with label parameters created using LLM like GPT-4 to generate sentences representing the extremes of each personality trait axis, according to some embodiments of the present disclosure. Each trait may align with specific behaviors, which may be randomly selected and defined for the LLM to generate extreme-point sentences. These sentences may be labeled accordingly: 1 for the targeted trait (e.g., Extraversion) and 0 for non-trait examples then ran through a regression algorithm. The technique involves providing definitions and variable prompts to the LLM, resulting in a more naturally separated set of sentences that illustrate behavioral extremes effectively. This method was found to yield better variability compared to fixed prompts previously tested.

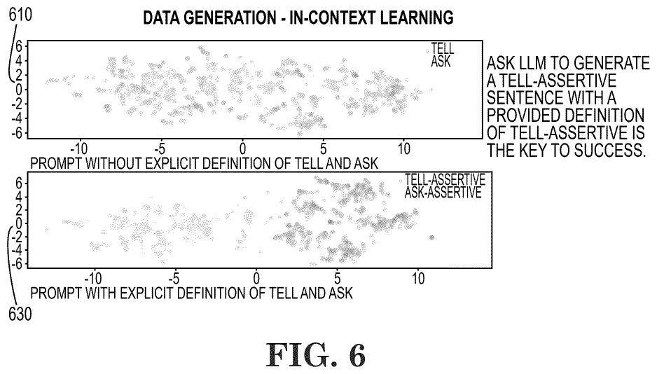

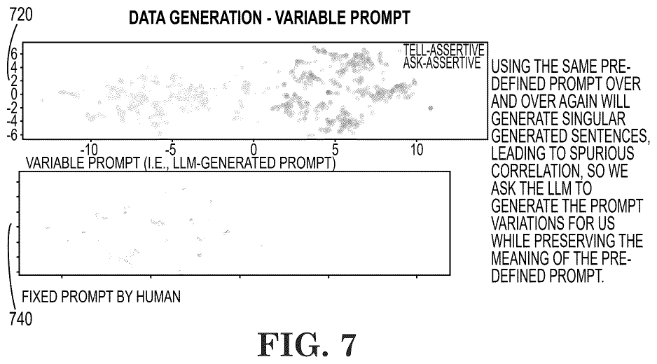

FIG. 6 shows a graphical comparison of providing the improved response generation engine with explicit definitions 610 of communication styles versus not providing such definitions 630, according to some embodiments of the present disclosure. FIG. 7 shows a graphical comparison of providing the improved response generation engine with variable 720 versus fixed 740 prompts, in accordance with some embodiments of the present disclosure.

In one embodiment, the model may be created by using algorithms found in the Azure ML platform, for example, to create classification and regression Machine Learning Models. Regression models can be trained using tens of thousands of labeled sentences that are generated for the model.

Model Validation. To create accurate machine learning models that can automatically label communication styles according to some embodiments of the present disclosure, the model should be validated through both automatic and/or manual means. A large language model may be used to automatically label various emails from public sources that have obvious leaning one way or another in the communication style to help check the validity of the model accuracy in the extremes of the communication spectrum. As additional validation, in some embodiments the model may further be improved through the use of behavioral psychology experts to manually label hundreds of sentences to compare it against the model output. Some embodiments of the present disclosure may only employ models where both the automatic and manual validation means result in high accuracy.

To further customize the system, AI using RAG may be used. In some embodiments, the system may include integration with company data in the workplace setting. Organizations can upload unstructured data to enrich LLM/Improved Response Generation Engine responses with context-specific information without retraining the model. The uploaded documents may be chunked into text and fed into a word embedding model, with the data stored in a vector database to enrich LLM Improved Response Generation Engine calls contextually. Embodiments may include team document sharing that allows shared documents within teams to enhance the draft and rewrite functions by quickly retrieving accurate product or company-specific information. Some embodiments may also include custom templates that enable the use of custom templates with specific documents for consistent and efficient email drafting.

In some embodiment of the present disclosure, the system analyzes at least four written communications, for example. The system may send these sample electronic communications to a large language model such as ChatGPT, for example, that may be incorporated into the Style Identification Engine, according to some embodiments. ChatGPT, for example, may be used to categorize the communication into one of a desired number of categories. For example, in some embodiments, the categories of interest may include ask/tell and people/data. In the following example according to some embodiments, the system may prompt the large language model of the Style Identification Engine with the following to determine David's communication type based on four e-mails he authored:

Prompt: Given these 4 social styles:
(1) Data-Tell Style. The Data-Tell Style is characterized by being decisive, fast-paced, and sometimes controlling. People with this style are perceived by others as action-oriented, direct, forceful, and determined. Extremely goal-oriented, they tend to focus their effort (and the efforts of others) on the objectives they want to get accomplished.
(2) People-Tell Style. The People-Tell Style is characterized by being enthusiastic and emotional. People of this style tend to make their feelings (both negative and positive) known to others and can seem to react impulsively to situations. Individuals with the Expressive Style are often perceived as personable, chatty, and sometimes opinionated.
(3) People-Ask Style. People with the People-Ask Style openly display their feelings to others. People with this style are often perceived as agreeable, informal, easy-going, and generally seem less demanding than others. They tend to prioritize relationships, and they need to feel personal security in order to perform their work.
(4) Data-Ask Style. Individuals with a Data-Ask Style are characterized by their tendency to look hard at the data and sometimes be cautious. People with this style are often perceived as quiet, logical, and sometimes reserved, and they tend to want to make sure they're correct before making a decision. Individuals with this style may not initiate communications unless they see a specific need to do so.

In this example, David has written the following emails: Email 1: “CC'ing Alvin, can we look at that outstanding balance? Thanks, David.”

Email 2: “Hey Tara and Jodie! As a heads up, our ACATs to DriveWealth will most likely be completed next month, in July, and not this month. Considering our recent trade issues, and that we're not adding new accounts but just going to be leaving, can we have a discount on our July bill? Thank you, David.”

Email 3: “Thanks! Anything for the email? And just confirming the address as XXXX. We are going to use ACAT, so is 1234 your ACAT clearing number?”

Email 4: “Hey all! We're getting ready to get ACAT forms signed. Can I verify the below info is what we should have on Drivewealth's ACAT forms? That address/phone number correct? Can I get an email and ACAT clearing number for Apex? Thanks, David.”

Based on the above prompt and these four emails, the system may provide the following assessment with a high level of certainty—that David's social style is Data-Ask. Rationale for this determination includes that David is task oriented. All of his emails are focused on specific tasks, such as getting the outstanding balance looked at, requesting a discount on his July bill, confirming the address and ACAT clearing number for Apex Clearing, and verifying the information on Drivewealth's ACAT forms.

David is cautious. He asks clarifying questions in all of his emails, such as “Anything for the email?” and “That address/phone number correct?” This suggests that he wants to make sure he has all of the information before making a decision.

David is logical. He uses clear and concise language in his emails, and he avoids using emotional language. This suggests that he is thinking things through logically before he communicates them. As such, in this example, based on four e-mails David authored, he was categorized as a Data-Ask type communicator by the system according to one embodiment.

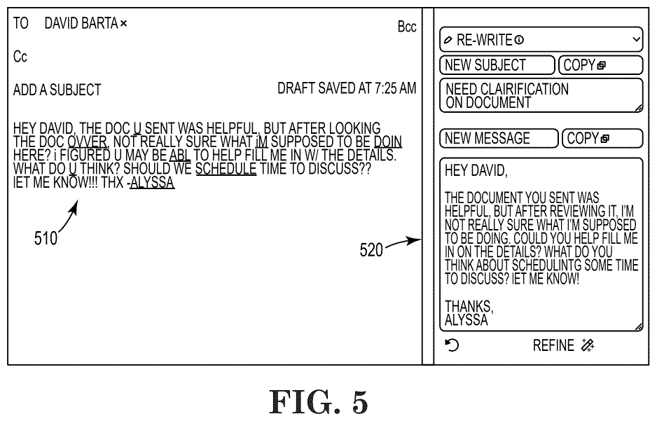

Embodiments of systems and methods of the present disclosure enable the system to suggest modifications to a written communication based on the recipient's communication type as determined by the system. In one embodiment, the rewriting of a communication to individuals modeled in the four or five or more (or less) quadrants is accomplished by sending a prompt to a large language model and/or other modules of the Improved Response Generation Engine and the response may be used to provide modifications to the written document. The system works in the background and when the user starts to draft a new e-mail or responds to an e-mail, the system automatically monitors the draft. In one embodiment, the system reminds the drafter of the communication type of the recipient based on the system's analysis of at least some of the e-mails authored by the recipient. Then, the system sends the Improved Response Generation Engine, a prompt to determine the appropriate modifications. For instance, as shown in FIG. 5, an initial email 510 has been rewritten in an improved style that is more suited to the recipient's communication style 520.

With a click of a button, the author may accept the suggested rewrites, reject them, or alter them. The author also has the ability to accept one or more of the suggested modifications. An advantage of certain embodiments of the present disclosure is that it provides an easy-to-use tool that runs in the background that provides the author with a rewritten e-mail or portions thereof that the recipient should understand much better, because it is written in the recipient's communication style. In short, in one embodiment of the present disclosure, the system is monitoring the drafting of an e-mail to the recipient; when the system determines that a drafter has stopped typing, the system may send a drafted version to a large language model and/or additional modules of the improved response generation engine, then upon receiving a response of a rewritten version of the draft sent to the improved response generation engine, the system provides this version to the drafter. With a click of a button, the drafter can accept and send the revised version.

In the following example, the query below was sent to a large language model, and/or additional modules of the improved response generation engine. Prompt: “I need to send a message to a colleague whose social style is Data-Tell. The Data-Tell style is characterized by being decisive, fast-paced, and sometimes controlling. People with this style are perceived by others as action-oriented, direct, forceful, and determined. Extremely goal-oriented, they tend to focus their effort (and the efforts of others) on the objectives they want to accomplish.

The following is the initial (unaltered) message: “Solidifying DW integration timeline, we may need to push 1-2 weeks, we need to push because we believe our estimates of the time to go through Drivewealth's certification program to get production keys to be too aggressive, so we want to extend our timeline to what we think has the highest probability of actually happening. And if there is a clear pattern for how DW account numbers are created, we can accurately guess what they will be now and use them on our ACAT forms. If there isn't a clear pattern, we will have to wait until post-certification, and then we'll create the accounts, get the actual DW account numbers, put them on our ACAT transfer forms, and then send the DocuSign forms to clients.” Then prompt the LLM with, “can you rewrite my message so my colleague with the driving style will understand better?”

The system may return with the following suggested email: “Subject: DW Integration Timeline Update: Hi [colleague's name], I'm writing to update you on the DW integration timeline. We're now projecting a 1-2 week delay. The reason for the delay is that our estimates for the time it takes to go through Drivewealth's certification program were too aggressive. We want to extend our timeline to what we think has the highest probability of actually happening. If there is a clear pattern for how DW account numbers are created, we can accurately guess what they will be now and use them on our ACAT forms. This will save us time and ensure that we can start transferring client accounts as soon as possible. If there isn't a clear pattern, we'll have to wait until after certification. At that point, we'll create the accounts, get the actual DW account numbers, put them on our ACAT transfer forms, and then send the DocuSign forms to clients. I'll keep you updated on our progress. Thanks, [Your name].”

Specific changes made to the message by the system to make it more clear and concise for a data-tell style colleague include: starting the message with a clear subject line that summarizes the main point of the message; getting to the point quickly and avoided using jargon or technical terms; using clear and concise language; emphasizing the actions that need to be taken; and ending the message with a call to action.

The system uses this response from the improved response generation engine and presents it to the author for the author to accept as a whole or to accept portions. The system enables the author to change the communication to the suggested communication with a single click in some embodiments. Because all of the analysis was being done in the background, the experience is seamless to the author, i.e. the prompts to the improved response generation engine do not come from the user, but from the system. In some embodiments, however, prompts may come, or may also come from a user, for example, a user may provide a prompt through a user interface to generate an email with a given set of information according to a particular recipient's communication style.

In the embodiment described above, the system determines a person's communication type in one of four quadrants. In another embodiment, the system can further define an individual's characteristics which may further refine the communication type of the individual. That is, within a single quadrant there may be much variation (not all Data-Tells are the same). So, in one embodiment, the system addresses this variation by modeling for specific characteristics within a quadrant or across the quadrants. The system can model the top five (or ten or any number) communication characteristics that an individual demonstrates in their written communication. This is a far more nuanced and individualized model. And not all five characteristics need to come from the same quadrant, they could be from all four quadrants. This allows the system to further define a more unique model of the recipient's communication style. The following example shows modeling an individual based on prior written e-mails using a large language model as part of the Style Identification Engine.

In this example, the following information was provided to the system for these 4 communication styles, Data-Tell, People-Tell, People-Ask, Data-Ask: START OF Data-Tell Style Characteristics. The Data-Tell Style is characterized by being decisive, fast-paced, and sometimes controlling. People with this style are perceived by others as action-oriented, direct, forceful, and determined. Extremely goal-oriented, they tend to focus their effort (and the efforts of others) on the objectives they want to get accomplished. With high assertiveness and low emotional response to others, Data-Tells are not so worried by how others react and are hence more independent and candid. With less concern about people, they have a greater concern for results and are quite pragmatic. They may also be poor collaborators and upset others with inconsiderate words and actions. They may be competitive and need to win, seek control and being in charge. They may be fast-acting, plan carefully, be decisive, results-oriented, and task-focused. They may dislike inefficiency and indecision. They can be impatient and insensitive. When stressed they may grab control and be overly critical.

The Data-Tell social style is more task-oriented, and more ‘tell’ oriented. Data-Tells are: Fast-paced. They will make quick decisions, speak quickly, walk quickly and they will expect deliverables “yesterday.” Action-oriented. They have a “better to do something rather than nothing” orientation. They will not always get it right, but that is not their goal, a good hit-rate is enough. Decisive, but willing to shift quickly. A Data-Tell has strong opinions, but if they see that their approach is not working, they are willing to adapt quickly (which can surprise and alarm other styles!). Highly independent. They want to be in control, and they are focused on the bottom line. This can backfire if they do not consider the needs of other people that they depend on. END OF Data-Tell Style Characteristics

START OF People-Tell Style Characteristics. The People-Tell Style is characterized by being enthusiastic and emotional. People with this style type tend to make their feelings (both negative and positive) known to others and can seem to react impulsively to situations. Individuals with the People-Tell Style are often perceived as personable, chatty, and sometimes opinionated. People-Tell people have higher assertiveness and greater responsiveness to others. With less concern for what others think they are typically articulate, quick and visionary. On the downside, their assertiveness may make them poor listeners and with a tendency to distract. This can also lead them to be impractical and impatient. They are typically, intuitive, creative, outgoing and enthusiastic, spontaneous and fun-loving. They interact well with others at work, are good at persuading and motivating, fear being ignored or rejected, but like to be acknowledged. They dislike routine and complexity, have a tendency to generalize and exaggerate, and when they are stressed may get sarcastic and unkind.

The People-Tell social style is people-oriented, and more ‘tell’ oriented. Analytics for this style include: ‘Big ideas’ people. People-Tells like bold ideas, big statements, and eye-catching projects. Impulsive. They go with their gut on what is right. As a result, they make more mistakes than most, but view this as part of getting things done. They are easily bored too, and do not do details. Full of energy. They talk first, think later and are bristling with energy and enthusiasm. They are always ready to embrace the next big thing. They share their emotions openly. Energized by connections. They will pick up the phone rather than send an email, and they would much rather meet face-to-face and talk. End OF People-Tell Style Characteristics.

START OF People-Ask Style Characteristics. People with the People-Ask Style openly display their feelings to others. People with this style are often perceived as agreeable, informal, easy-going, and generally seem less demanding than others. They tend to prioritize relationships, and they need to feel personal security in order to perform their work. People with higher responsiveness than others and lower assertiveness are people-oriented and sociable. Without a need to lead, they can be steady and reliable workers. They may also avoid any conflict and be rather passive, lacking drive and becoming careless. They may typically include the following traits: friendly and relates well to others, good at listening and teamwork, wants to be respected, liked and approved of, dislikes conflict and risk-taking, seeks security and likes organized workplaces. They may be slow decision-makers, prefer to be told what to do rather than lead, fear change and uncertainty, and when stressed may become indecisive and submissive. The People-Ask social style is people-oriented, and ‘ask’ oriented. People-Asks are typically: Warm, friendly, and easy-going. They are sensitive to other people's feelings and emotions. Team-players. They are generous with their time and want to hear from others. They value making decisions by consensus. Relationship-focused. This is a strength but can also lead to an unwillingness to confront performance issues. Risk-averse. They work best in a stable environment and will seek to reduce risk in decision-making. END OF People-Ask Style Characteristics

START OF Data-Ask Style Characteristics. Individuals with a Data-Ask Style are characterized by their tendency to look hard at the data and sometimes be cautious. People with this style are often perceived as quiet, logical, and sometimes reserved, and they tend to want to make sure they're correct before making a decision. Individuals with this style may not initiate communications unless they see a specific need to do so. Data-Ask people are less assertive and less responsive to others. They hence tend to focus more on tasks than people and are less interested in leading, being happier to work by themselves. They may be prudent and systematic, making them good at analytic work. They may also pay excessive attention to detail in ways that annoy others. People of this character type may typically: focus on tasks more than people, like to be right and will take time to ensure this, be thoughtful, careful fact-oriented and precise, good at objective evaluation and problem-solving, likes organization and structure, avoid group work, preferring to work alone. They can be over-critical and unresponsive, cautious in decision-making, and when stressed may withdraw or become headstrong. The Data-Ask social style is equally task-oriented, and more ‘ask’ oriented. Analytics for this type include: Highly focused. They set high standards (for themselves and others), they are detail oriented and expect to deliver quality work. Data oriented. They want to make decisions based on data, the more the better. Systematic and well organized. They like to take a structured approach and methodical approach. Introverts. They are quiet and private by nature, preferring to work alone or in small groups. Their quiet style may make them seem reserved. End OF Data-Ask Style Characteristics.

David's sample emails provided to the Style Identification engine along with the above definitions include: Email 1: “CC'ing Alvin, can we look at that outstanding balance? Thanks, David.” Email 2: “Hey Tara and Jodie! As a heads up, our ACATs to DriveWealth will most likely be completed next month, in July, and not this month. Considering our recent trade issues, and that we're not adding new accounts but just going to be leaving, can we have a discount on our July bill? Thank you, David.” Email 3: “Thanks! Anything for the email? And just confirming, XXX, We are going to use ACAT, so is 1234 your ACAT clearing number?” Email 4: “Hey all! We're getting ready to get ACAT forms signed. Can I verify the below info is what we should have on Drivewealth's ACAT forms? That address/phone number correct? Can I get an email and ACAT clearing number for Apex? Thanks, David.”

The system may be prompted to provide the top five most recurring characteristics David expresses in his emails and which primary communication style each characteristic relates to. As well as which communication style David displays most frequently.

The system provides the following information, including the top five most recurring characteristics and the primary communication style each characteristic relates to:

| Characteristic | Social Style |
|---|---|
| Direct and to the point | Data-Tell |
| Task-oriented | Data-Tell |
| Fact-oriented | Data-Ask |
| Organized and structured | Data-Ask |
| Concise | Data-Ask |

In aggregate, David displays the Data-Ask communication style most frequently. This is evident in his emails, which are typically direct, task-oriented, fact-oriented, organized, and concise. David also tends to use a lot of acronyms and abbreviations in his emails, which is another characteristic of the Data-Ask social style.

Here are some specific examples of how David's emails exhibit the Data-Ask social style:

In Email 1, David uses the acronym “ACAT” to refer to the Automated Customer Account Transfer process.

In Email 2, David provides a detailed list of the trade issues that have affected his company.

In Email 3, David asks for specific information about Apex Clearing's address, phone number, and ACAT clearing number.

In Email 4, David asks for confirmation that the information he has provided is correct. Overall, David's emails are well-organized and concise, and they focus on the task at hand. This suggests that David is a Data-Ask communication style.

As the example shows, the system defined the communication style by identifying five characteristics based on the analysis of four e-mails authored by the person. As the example shows, the characteristics were across two different quadrants. This refinement will further refine the rewrites of e-mails to this person.

The following shows an example of how the system proposes rewrites of an e-mail to a recipient modeled for his/her communication style as described above. With this more detailed model of an individual's communication style, the system can rewrite text in a far more nuanced and personalized way to the recipient, thus leading to an improved communication beyond merely the quadrant model. The following is an example of such a rewrite: Prompt: rewrite an email for a colleague who displays these top five characteristics in their communication style: 1. Direct and to the point; 2. Task-oriented; 3. Fact-oriented; 4. Organized and structured; 5. Concise.

The original email reads: “Solidifying DW integration timeline, we may need to push 1-2 weeks, we need to push because we believe our estimates of the time to go through Drivewealth's certification program to get production keys to be too aggressive, so we want to extend our timeline to what we think has the highest probability of actually happening. And if there is a clear pattern for how DW account numbers are created, we can accurately guess what they will be now, and use them on our ACAT forms. If there isn't a clear pattern, we will have to wait until post-certification, and then we'll create the accounts, get the actual DW account numbers, put them on our ACAT transfer forms, and then send the Docusign forms to clients.” Prompt: rewrite my message so it uses the style of the top five characteristics of my colleague's communication style.

The system may respond with: “Subject: DW Integration Timeline Update. Hi [colleague's name], I'm writing to update you on the DW integration timeline. We're currently projecting a 1-2 week delay, due to our estimates of the time to go through Drivewealth's certification program to get production keys being too aggressive. As a result, we're extending our timeline to what we believe has the highest probability of actually happening. If there is a clear pattern for how DW account numbers are created, we can accurately guess what they will be now, and use them on our ACAT forms. If there isn't a clear pattern, we will have to wait until post-certification. At that time, we'll create the accounts, get the actual DW account numbers, put them on our ACAT transfer forms, and then send the Docusign forms to clients. I'll keep you updated on our progress. Thanks, [Your name].”

This email is more direct and to the point by stating the main message in the first sentence. It is also more task-oriented by focusing on the specific tasks that need to be completed. The email is fact-oriented by providing specific details about the timeline and the account number pattern. It is organized and structured by breaking the information into clear paragraphs. Finally, the email is concise by avoiding unnecessary words and phrases.

This rewrite would be presented to the author and allows the author to accept, reject, or revise the rewrite with a click of a single button in some embodiments.

In another embodiment, the system may identify to the would-be sender of an electronic communication, individual phrases that do not align with the intended recipient's communication style. In some embodiments, the system may employ, for example, a top five (or any number) characteristic model to identify one or more attributes of the recipient's communication style. The system may then identify which sentences/phrases the sender has drafted that do not match the identified style of the intended recipient and may recommend improvements or alterations for the sender to consider that are more in line with the recipient's identified communication style. While in some embodiments systems and methods of the present disclosure may include rewriting entire emails/text communications, in some embodiments of the systems and methods of the present disclosure, only some part or parts of written communications may be rewritten, for example, one or more phrases.

In some embodiments, the system may include, or also may include, providing insight into internal organizational communications, and in some cases real-time insights. In some embodiments, this information may be provided as a real-time sentiment-metric feed that only authorized entities, in some embodiments, can access. In some embodiments, employee communications that may be accessible to the organization in electronic form may be used as inputs for a sentiment analysis engine according to systems and methods of the present disclosure that may provide feedback, and in some cases, real time feedback to administrators of the organization that the administrators may then act on, if desired. In some embodiments, the inputs may include, but not be limited to email, chat messages, and/or any other communication format from any relevant platform that is accessible to the organization. In some embodiments, the system may include a sentiment analysis engine that may employ a natural language processing (NLP) model, such as a large language model (LLM), to evaluate some or all of the communications that may be collected for analysis. For example, an administrator may decide to only analyze email messages for a given employee or group of employees from a certain period of time to another specified period of time. Though it will be understood that any parameters for determining which communications should be analyzed may be used.

In some embodiments, the sentiment analysis engine may review the determined communications and provide an insight report related to the analyzed communications. For example, in some embodiments, the communications may be rated on a positive to negative sentiment scale, whereby the rating may tell the administrator or other designated company personnel authorized to review the report how positive, neutral, or negative the one or more analyzed communications may be. Any scoring or rating system may be used, including a numeric scale, a colored scale, a graph, etc. In one embodiment, a normalized sentiment score may be assigned, for example, on a scale ranging from −1.0 (strongly negative sentiment) to +1.0 (strongly positive sentiment), with 0.0 representing a neutral sentiment. In other embodiments, the sentiment analysis engine may analyze one or more communications for other communication attributes other than positivity/negativity. For example, communications may be analyzed for work focus/time wasting, motivated/frustrated, and/or any other identified parameter or scale.

In some embodiments, sentiment scores may be computed for each discrete communication, while in some embodiments one or more sentiment scores may be aggregated across multiple hierarchical dimensions, including individual employees, team groups, and organizational departments to generate an insight report that may include one or more scores. In some embodiments, the insight report generated from the sentiment analysis engine scores may be displayed through interactive features provided on a dashboard interface that in some embodiments may be accessible to only authorized personnel, such as for example, an executive dashboard interface.

For instance, in some embodiments of a dashboard interface, such as an executive dashboard interface, a heatmap may be generated to represent average sentiment scores across departments, with for example, red indicating negative sentiment and, for example, green indicating positive sentiment, which may allow executives to quickly understand a large volume of aggregated information related to the positivity/negativity of a given segment of the company or group, versus one or more other segments or groups of the company. Of course, it will be understood that the insight report information need not be comparative in nature but may also be provided for an individual or a single segment or group. In some embodiments, one or more filter parameters (e.g., regional office, project team) can be supplied with an API request, i.e., a structured call from the system to an external or internal application programming interface, to the system to retrieve subgroup-level sentiment metrics. Further, in some embodiments, systems and methods of the present disclosure may include, or may also include a time-series analysis module that may track changes in sentiment scores over defined time intervals (e.g., daily, weekly, monthly, or any other desired period of time).

In some embodiments, the time-series analysis module may detect anomalies by comparing current sentiment trajectories to historical baselines. For example, a sustained drop of more than 0.3 points in average sentiment within a 72-hour period may trigger a visual alert on the dashboard, prompting leadership attention and potentially intervention. Anomaly thresholds may be configurable by administrators based on organizational tolerance or event sensitivity and may be any desired threshold and/or time period.

In one embodiment, the present disclosure employs a behavior-aware communication engine that analyzes communications in real time to reveal interaction patterns such as, but not limited to, assertiveness level, conversational dominance, hedging frequency, and deviations from established stylistic norms. Unlike the sentiment-analysis engine described above—which in some embodiments focuses on classifying messages along a scale, for example a positive-to-negative affect scale—the behavior-aware engine concentrates on structural and stylistic signals that can forecast misalignment or friction before it escalates. Of course, in some embodiments the two engines may work together. The behavior-aware engine may employ natural-language-processing (NLP) components, including large language models (LLMs), to tag each communication or parsed communication against a behavioral taxonomy covering, for example, assertiveness, directness, social dominance, use of clarifying questions, red-flag phrases, and/or inferred Big Five personality cues, and/or other attributes. The engine may also detect conversational anomalies (e.g., unusually abrupt replies or sudden silence) and forward these signals to a miscommunication-risk module or other desired person or module for further processing. Additional or alternative behavioral markers can be configured without departing from the scope of the present disclosure.

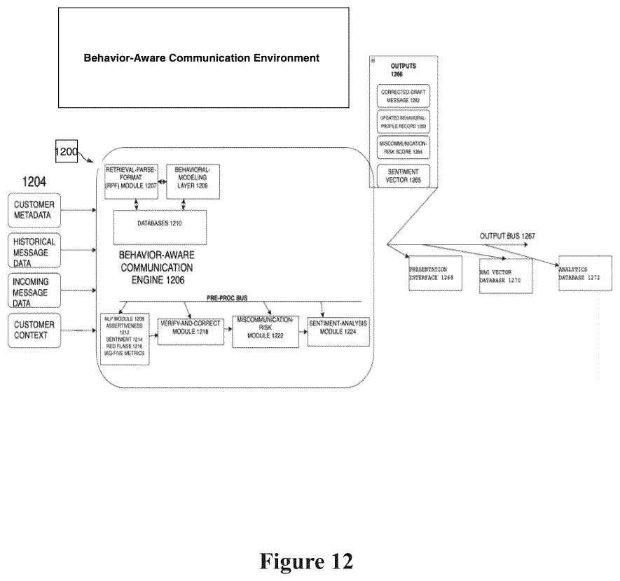

FIG. 12 shows behavior-aware communication environment 1200, which includes a behavior-aware communication engine 1206 that can operate as an additional engine within the system of FIG. 3, for example, or any other system or method disclosed herein. The behavior-aware engine may be in operable communication with the style identification engine, the improved response generation engine, and/or the verify and correct engine, and/or additional or fewer engines or modules. As shown, the behavior-aware communication engine 1206 receives inputs 1204 from one or more sources, including, but not limited to, for example customer metadata, historical message data, incoming message data, and customer context, though it will be understood that other or different inputs may be included, including input from one or more other engines. In some embodiments, the communication engine 1206 may process the one or more inputs 1204 using a retrieval-parse-format (RPF) module 1207 and/or a behavioral-modeling layer 1209 that may access one or more databases 1210, for example one or more vector databases, relational databases, and/or graph databases 1210. It will be understood that other or different databases may be included in other embodiments.

The communication engine 1206 may comprise a plurality of integrated functional components. It will be understood however that tasks or functions described as being performed within a particular engine or module may of course be performed by one or more other engines, etc. The communication engine may include one or more modules, including an LLM-based natural-language-processing module 1208 (configured to analyze attributes such as assertiveness 1212, sentiment 1214, red flags 1216, and/or Big Five personality traits, for example), a verify-and-correct module 1218, a miscommunication-risk module 1222, and/or a sentiment-analysis module 1224, for example. It will be understood that additional or alternative modules may be incorporated in other embodiments, and that the specific terminology used to describe a component does not limit its scope or function.

The communication engine 1206 may generate one or more outputs, collectively referenced as outputs 1266. In the illustrated embodiment, the verify-and-correct engine 1218 produces a corrected-draft message 1262; the miscommunication-risk engine 1222 produces a miscommunication-risk score 1264; the NLP engine 1208 writes an updated behavioral-profile record 1263 that captures assertiveness, sentiment, red-flag counts, and Big Five metrics; and the sentiment-analysis engine 1224 produces a sentiment vector 1265. These outputs travel along an output bus 1267 to a presentation interface 1268, a retrieval-augmented-generation (RAG) vector database 1270, and an analytics database 1272. Alternative embodiments may route these or additional outputs to other destinations, such as API endpoints for downstream systems or compliance archives.

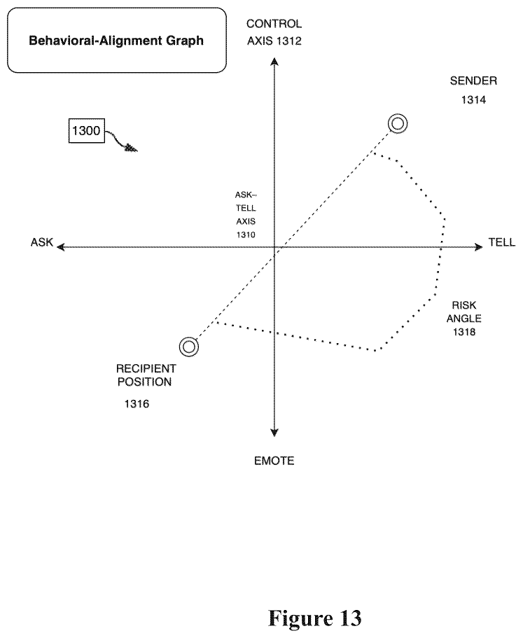

FIG. 13 illustrates behavioral-alignment graph 1300 and the operation of miscommunication-risk score module 1264. Communication-feature extractor 1262 first derives, for each conversational participant, an Ask/Tell scalar a∈[−1, +1] and a Control/Emote scalar c∈[−1, +1] by applying natural-language-processing routines (for example, large-language-model inference, sentiment parsing, and speech-act tagging) to the raw message corpus. Module 1264 interprets each ordered pair (a, c) as a Cartesian coordinate and plots sender point 1314 and recipient point 1316 within graph 1300, whose horizontal axis is orthogonal ASK-TELL axis 1310 and whose vertical axis is orthogonal CONTROL-EMOTE axis 1312.

From the graph origin O (0, 0), the module constructs radial vector v_S to point 1314 and radial vector v_R to point 1316. It then calculates risk angle θ 1318 as the smaller included angle between vectors v_S and v_R. The module maps θ to a unit-interval scalar by applying a strictly monotonic function f, yielding s=f(θ)∈[0, 1]. In some embodiments, s is further multiplied by the larger of the two vector magnitudes to weight the score by stylistic intensity. The resulting numeric miscommunication-risk score s is placed on system output bus 1267.

In some embodiments, output consumers operate as follows. Presentation interface 1268 compares s with a configurable threshold and, when the threshold is exceeded, provides real-time clarification prompts to the sender. Retrieval-augmented-generation vector database 1270 indexes the score alongside the current conversational context, enabling selection of follow-up questions that are sensitive to detected misalignment. Analytics database 1272 stores timestamped tuples (conversation identifier, s) to support longitudinal reporting on organizational communication quality.

By way of example, if the sender occupies coordinate (+0.70, −0.20) and the recipient occupies coordinate (−0.40, +0.60), the vectors form an angle of approximately 95 degrees; mapping that angle with f produces a score of about 0.53, which is then scaled to approximately 0.38 after intensity weighting. A score in this range signifies moderate risk and triggers a low-priority clarification prompt.

Alternative embodiments may substitute one or both stylistic axes with other orthogonal attribute pairs—such as Formal/Informal or Concise/Elaborate—to tailor alignment analysis to specialized domains like regulatory filings or customer-support chat, for example. The angular measure may likewise be replaced with Euclidean distance, cosine similarity, or any differentiable divergence metric, provided that the resulting scalar remains bounded and is communicated via bus 1267 in some embodiments.

The miscommunication-risk score module 1264 receives, for each conversation party, an Ask/Tell coordinate and a Control/Emote coordinate produced by the communication-feature extractor 1262. It plots those coordinates on the behavioral-alignment graph defined by the orthogonal ASK-TELL axis 1310 and CONTROL-EMOTE axis 1312, draws a radial vector from the origin to each plotted point (sender 1314 and recipient 1316), and measures the risk angle 1318 as the smaller included angle between the two vectors. A monotonic mapping of that angle—optionally scaled by the larger of the two vector magnitudes—yields a numeric miscommunication-risk score. The module places this score on the output bus 1267, where it is received by the presentation interface 1268 (to provide real-time clarification prompts), the retrieval-augmented-generation vector database 1270 (to select context-appropriate follow-up questions), and/or the analytics database 1272 (to track longitudinal communication quality), for example. Alternative embodiments may use alternative traits instead of the ASK-TELL and CONTROL-EMOTE dimensions for other attribute pairs (e.g., Formal/Informal) or replace the angular measure with Euclidean distance or cosine similarity while leaving the rest of the scoring pipeline unchanged.

In some embodiments, a behavioral style-matching framework may incorporate additional or alternative insights, reports, graphs, metrics, and/or dimensions based on the needs of the organization, the industry context, and/or the communication platform. For example, the framework may include an output graph with a directness-indirectness axis to distinguish between blunt or declarative styles versus more nuanced or suggestive language; a formal-informal continuum to capture differences in tone, use of slang, or adherence to professional conventions; a brevity-elaboration axis to identify mismatches in message length expectations; or a sentiment polarity axis to account for tone differences such as optimism versus skepticism. Further, the framework may evaluate cultural or regional language norms (e.g., high-context versus low-context communication styles), industry-specific jargon density, risk aversion in word choice, or even time-sensitivity cues in message construction. In some embodiments, these axes may be customized or weighted differently based on organizational policies, user roles (e.g., executive vs. support staff), or historical communication patterns between specific individuals or teams, for example.

In some embodiments, the system may generate a behavioral communication profile for each one or more entities, including but not limited to, authorized users, such as an employees, contractors, or other individual(s) whose communications are processed by the system in accordance with organizational policies. These users may include individuals who send or receive internal or external communications using supported platforms (e.g., email, chat, or messaging applications) and whose historical message data is available for analysis. In some embodiments, the system-generated profile may be generated based on historical language usage derived from previously sent and received messages, as shown in FIG. 12 The ask-tell axis 1310 may quantify the degree to which a user's communication style may include seeking input versus asserting conclusions, while the control-emote axis 1312 may evaluate whether the user's language may tend to be more directive or emotionally expressive. These behavioral profiles may enable the miscommunication risk module 1222 to detect stylistic mismatches, assess the likelihood of miscommunication, and generate adaptive prompts or rewrite suggestions to improve alignment between sender and recipient. The profiles may be produced using supervised machine learning models trained on labeled communication patterns. The user profiles may be updated dynamically as new communications are analyzed by the system.

When a would-be sender drafts an outbound message to a particular recipient, communication-feature extractor 1262 derives the sender's instantaneous Ask/Tell score a_S and Control/Emote score c_S on the unit interval [−1, +1]. These unit-interval values are linearly converted to a 0-to-100-point scale via p=round((v+1)×50), where v represents either a_S or c_S, so that −1 maps to 0 points and +1 maps to 100 points. The system then subtracts the recipient's stored baseline Ask/Tell and Control/Emote points p_R from the sender's corresponding points p_S to obtain absolute deltas ΔS_A/T and ΔS_C/E on orthogonal ASK-TELL axis 1310 and CONTROL-EMOTE axis 1312, respectively.

If either delta exceeds a configurable threshold held in threshold register 1274—for example, ΔS>50 points for a red-flag condition or 25<ΔS≤50 points for a yellow-flag condition—the miscommunication-detection logic assigns a proportional risk level. It forwards the flagged draft, together with the computed deltas, to presentation interface 1268. Interface 1268 generates concrete rewrite suggestions (for instance, softening directives or adding affiliative language) that, if accepted, reduce ΔS below threshold before transmission. When both deltas remain at or below 25 points, the logic returns a green status that clears the draft for immediate sending. Other point mappings, threshold values, or label schemes may be substituted without departing from the scope of the invention.

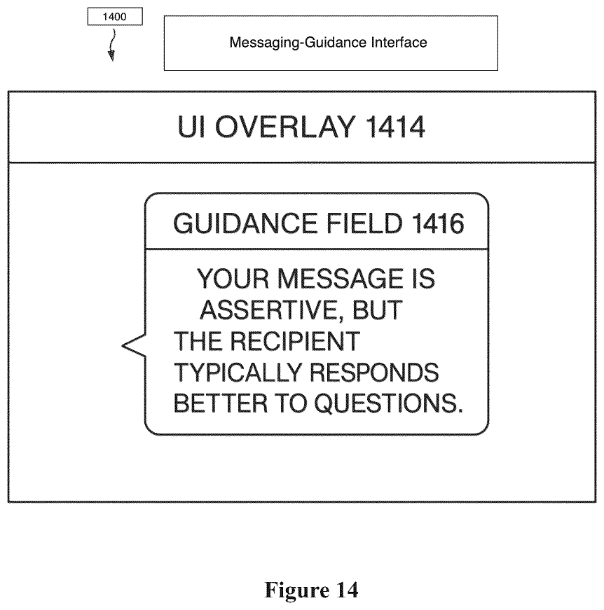

FIG. 14 shows messaging-guidance interface 1400, implemented as user-interface overlay 1414 that delivers a risk classification to the sender within the communication platform (e.g., an email client or messaging app). The accompanying insight report includes explanatory feedback 1416 such as “Your message is assertive, but the recipient typically responds better to questions.” This real-time guidance enables the sender to adjust tone or structure, improving alignment between communicators and reducing the risk of miscommunication.

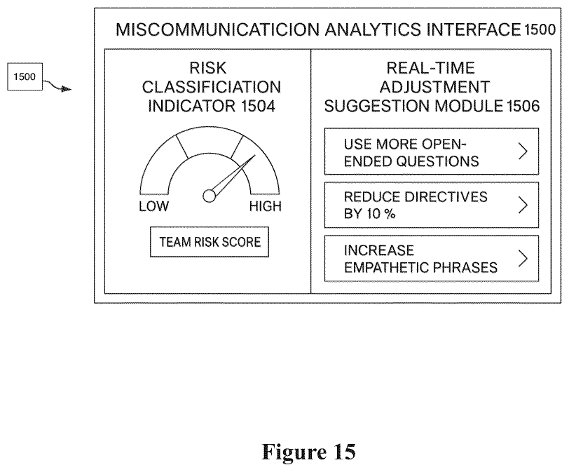

In some embodiments, aggregate communication/miscommunication trends may be provided in an intuitive manner, where the trends may be aggregated at the team or organizational level, enabling people/leaders to identify patterns of friction, mismatched communication styles, or teams requiring intervention. FIG. 15 shows miscommunication-analytics analysis 1500 rendered by the system in response to real-time conversational data. In some embodiments, aggregated communication/miscommunication trends may be provided in an intuitive manner, where the trends may be aggregated at the team or organizational level, enabling people/leaders to identify patterns of friction, mismatched communication styles, or teams requiring intervention, and/or any other desired and measurable information. Analysis 1500 includes a risk-classification indicator 1504, which distills underlying behavioral-divergence metrics into a categorical or graduated risk level that an end user can grasp at a glance, thereby facilitating rapid situational awareness. Analysis 1500 further includes a real-time adjustment-suggestion module 1506, which algorithmically generates context-specific mitigation guidance, such as modulation of tone, insertion of clarifying inquiries, or adaptive message framing, based on the risk level assigned by indicator 1504. Additional or alternative visual components, analytical widgets, or interactive controls may be incorporated in other embodiments without departing from the scope and spirit of the present disclosure.

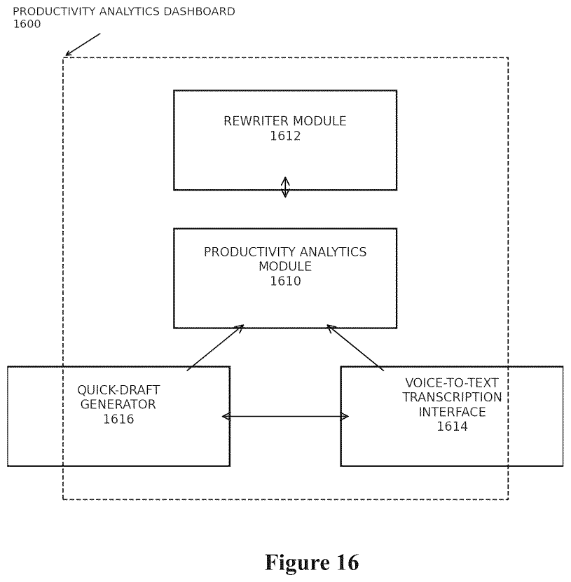

FIG. 16 depicts productivity-analytics dashboard 1600. Productivity-Analytics Module 1610 may be a distinct service layer that instrumentally monitors—but does not itself execute—the communication-assistance engines described elsewhere in the specification. In particular, in some embodiments, the Productivity-Analytics Module receives usage telemetry from Improved Response-Generation Engine 340 of FIG. 3 as well as from Rewriter Module 1612, Voice-to-Text Transcription Interface 1614, and/or Quick-Draft Generator 1616, for example. Module 1610 may be communicatively coupled to these engines through event bus 321 and records invocation counts, edit-acceptance rates, draft-submission times, and/or related metrics, for example. For each event, the Productivity-Analytics Module estimates time saved relative to a baseline manual workflow by applying empirically derived coefficients stored in lookup table 1618, in some embodiments. The module 1610 aggregates per-action savings across users and time periods and presents the results on dashboard 1600, thereby quantifying organizational efficiency gains attributable to the automated communication-assistance tools without duplicating the rewriting functions performed by Engine 340, in some embodiments.

In some embodiments, the system may quantify time saved through three primary communication phases: writing, reading, and editing. For writing-related tasks, the system may measure time saved when users utilize the rewriter module 1612 and/or quick-draft features 1616, for example, to generate message content rather than composing text manually. This may include comparing an average keystroke rate against the number of characters generated by the system. For reading tasks, the system may calculate the reduction in time spent on message review by comparing the length and complexity of original drafts against the simplified or restructured output produced by the rewriter module 1612. For editing-related actions, time saved may be estimated by evaluating reductions in revisions or backspacing following use of rewrite suggestions. It will be understood that other measures for determining time savings may also be used.

Time-saving metrics may be calculated on a per-message basis and aggregated along any desired dimension, including time intervals such as daily, weekly, or monthly windows, user roles such as individual contributors or managers, and organizational units such as departments or project teams, for example. In some embodiments, these metrics may be persisted in a time-series database and exposed through a metrics-query application programming interface so that visualization or reporting components can retrieve the data on demand. The interface may render the analysis through any suitable means, including, but not limited to, for example bar charts, line graphs, or heatmaps that trace relative productivity gains over time.

In one embodiment, a user-specific productivity dashboard displays cumulative time saved over a defined period together with a categorical breakdown, for example one hour saved on writing and forty-five minutes saved on editing. An organization-level view may enable administrators or executives to evaluate return on investment by correlating time-saved metrics with workforce adoption rates and overall communication volume.

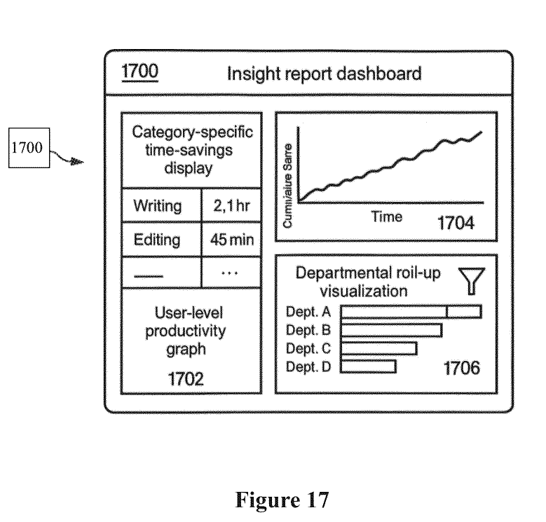

FIG. 17 shows insight report 1700 on a user-interface dashboard that visualizes the foregoing time-saved analytics. The report 1700 includes a category-specific time-savings display 1702 that enumerates discrete task types, a user-level productivity graph 1704 that plots the cumulative savings attributed to the current user across the selected period, and a departmental roll-up visualization 1706 that aggregates savings across peer groups while enabling interactive filtering and cross-team comparison. By coupling elements 1702, 1704, and 1706 with the underlying metrics database, the dashboard 1700 may deliver a real-time, multi-resolution view of productivity gains that informs both individual work habits and enterprise-wide strategic decisions, in some embodiments.

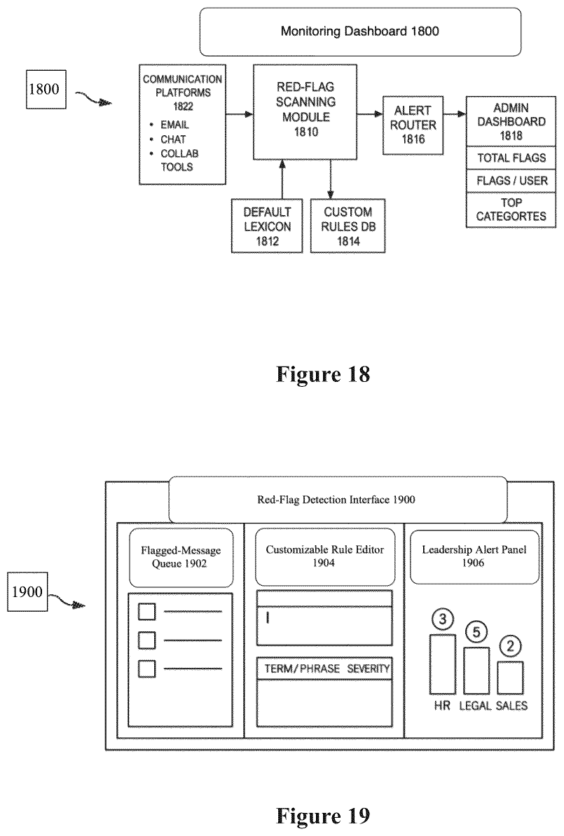

FIG. 18 shows red-flag monitoring dashboard 1800, which incorporates a red-flag scanning module 1810 that is configured to identify potentially harmful, offensive, policy-violating language, and/or other undesirable communication behaviors, within digital communications authored by employees or other users. The red flag scanning module may be operatively integrated with the organization's communication platforms 1822 (e.g., email clients, chat systems, or collaboration tools), though it will be understood that other or different communication channels may be monitored in other embodiments, and may monitor both outbound and internal messages in real time or near real time.

In some embodiments, the red flag scanning 1810 module may utilize a two-tiered approach to flagging content, though it will be understood that additional or alternative tier structures may be implemented in other embodiments. The first tier may comprise a default lexicon 1812 of pre-defined red flag terms and phrases that are commonly associated with offensive, discriminatory, harassing, or otherwise inappropriate content. This default lexicon may include terms linked to sensitive topics such as profanity, slurs, sexual harassment, discrimination, and/or threats of violence. The second tier may allow for an organization-specific customized dataset 1814, enabling administrators to define their own set of flagged terms and expressions. For example, a financial institution may choose to flag terms like “guaranteed returns,” “non-disclosed,” or “off the books” as high-risk phrases. Custom red flag rules may be added manually or uploaded in batch via administrative interface. In some embodiments, an organization may edit some or all of the default lexicon 1812 to match company policy and/or culture, etc.

Upon detecting a red flag instance, the red flag scanning module 1810 may generate a contextual alert that may include the surrounding sentence or paragraph for review. These alerts may be automatically routed 1816 to company-identified personnel, for example, designated leadership personnel, such as department heads, HR compliance officers, or legal counsel, though it will be understood that other or different alert recipients or routing rules may be specified in other embodiments. The system may group alerts by type, severity, recurrence, or sender to facilitate pattern recognition and risk mitigation. In some embodiments, red flag occurrences may be assigned a severity score based on, for example, frequency, linguistic intensity, and/or the recipient's profile (e.g., external client vs. internal staff).

Summaries of flagged activity may be made available through an administrative dashboard 1818, though other or different reporting mechanisms (e.g., periodic email digests or API endpoints) may be utilized in other embodiments. The report may display in some embodiments aggregated data over defined time intervals, including total flag count, flags per user, and/or flag categories most frequently triggered, for example. Filters may be applied that may allow review of any number of parameters, for example, but not limited to, specific phrases, employee groups, and/or communication channels. In one embodiment, the system includes retrospective audits of flagged messages for investigatory or compliance purposes.

FIG. 19 shows red-flag detection interface 1900. In some embodiments, the interface comprises: (i) a flagged-message queue 1902 that presents a selectable list of messages whose content has triggered a red-flag rule, allowing reviewers to open each message, inspect the surrounding context, and mark the item as resolved or escalate it further; (ii) a customizable rule editor 1904 through which authorized administrators may add, modify, or disable red-flag rules—e.g., by editing the default lexicon or uploading organization-specific terms, assigning severity levels, and defining automated routing actions; and (iii) a leadership alert panel 1906 that surfaces high-severity or high-frequency flag events in an at-a-glance summary, displaying counts by department, trend indicators, and quick-action controls for escalation to human-resources, legal, or executive stakeholders. Collectively, elements 1902, 1904, and 1906 provide administrators with an end-to-end workflow for identifying, triaging, and remediating communication risks across the organization, although alternative layouts, visualizations, or interface components may be employed in other embodiments.

In certain embodiments, the system may include a manager-facing coaching dashboard that may provide actionable insights into communication patterns, sentiment trends, and relational dynamics among members of a specific team or workgroup. The dashboard may be tailored for use by people-leaders, such as direct managers or department heads, and may enable enhanced oversight of interpersonal communications within a defined reporting structure. The information may allow a company to help train existing or new managers, and/or improve managers' people skills. By providing feedback, and in some cases substantially real-time feedback about the communication styles preferred by the people managed, managers may more effectively tailor their communication style to each of those people they manage.

As shown in FIGS. 12 and 13, the insight-report dashboard may include the electronic exchanges that sentiment-analysis engine 1224 and miscommunication-risk module 1222 have already processed and annotated. In some embodiments, for each sender-recipient dyad, the sentiment-analysis engine 1224 supplies normalized sentiment scores, while the miscommunication-risk module 1222 contributes pairwise risk metrics such as flag frequency, historical shifts in alignment, and tone-consistency indicators. The dashboard provides results of these analyzed values.

In some embodiments, the system may include on a system dashboard, user-specific information related to that user's communication with one or more people inside and/or outside of the organization. The dashboard may provide such information in a variety of ways. In one embodiment, for example, a matrix of communication relationships, with visual indicators such as color-coded sentiment trends and risk flags may be provided to inform the user of various attributes of their communication effectiveness with others. For example, a green line connecting two team members may indicate a positive and consistent communication relationship, while a red line may signal persistent negativity or misalignment. Managers may, in some embodiments, be able to view each user's information that is on the manager's team to help facilitate improved communication between that team member and others. The manager may also receive user specific feedback to maximize the manager's communication with the members of the manager's team and others. In some embodiments, the user specific information may include communication histories, trend graphs, and/or summaries of key risk indicators, for example. Other and/or different visual indicators may be employed in alternative embodiments.

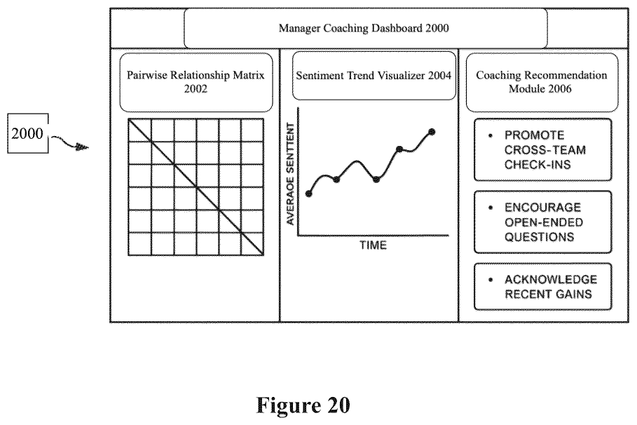

FIG. 20 shows manager-coaching dashboard 2000, which in some embodiments may provide user-specific relationship data drawn from one or more engines, including for example, but not limited to sentiment-analysis engine 1224 and/or miscommunication-risk module 1222. The pairwise relationship matrix 2002 may render color-coded links—green denoting consistently positive exchanges, red indicating persistent misalignment—and provide filters for internal versus external communications so managers can isolate workplace dynamics. The sentiment-trend visualizer 2004 in some embodiments may plot dyad-level tone across selectable intervals, allowing leaders to see how patterns shift during high-stress periods such as deadlines or reorganizations, for example. When divergence metrics exceed a threshold, the coaching-recommendation module 2006 may provide talking points, behavioral-style insights, and/or AI-generated feedback templates tailored to the parties involved, for example. Managers may drill into any node to review communication histories, trend graphs, and key risk indicators to reassess team assignments based on current trust scores, though alternative layouts, visual indicators, for example, or additional filters may be employed in other embodiments without departing from the scope of the present disclosure.

The user-specific and/or manager dashboard may also include analytics related to communication over specific intervals. For example, by providing feedback about whether or how communication patterns change during high-stress periods (e.g., project deadlines) and/or organizational changes (e.g., team restructuring), for example. Managers may use this information about their team members to decide who to put on a given assignment to achieve the best result. Additionally, in some embodiments, users and/or managers may filter the communications that are used as inputs to drill down into more specific categories of communication. For example, communication inputs may be filtered by internal versus external communications to isolate workplace dynamics, though it will be understood that other or different temporal analytics or filters may be used.

Some embodiments may use a different behavioral framework for analysis and/or may include one or more additional behavioral frameworks as an analysis base for systems and methods of the present disclosure. For example, one or more of the following social styles may be ranked on two dimensions, as shown. It will be understood that more than two dimensions may be ranked in some instances and/or additional or different social styles may be ranked and/or analyzed.

| | | | | Examples of |
|---|---|---|---|---|
| | | | | Opposite |
| Dimension | What It Captures | Pole A | Pole B | Preferences |
| 1. | How they prefer | Conversational- | Asynchronous- | A wants a chat to |
| Communication | to connect. | likes calls, | prefers email, | “feels heard”; B |
| Channel | | meetings, in- | text, or portal | just wants a |
| | | person talk | updates | bullet summary |
| 2. Relational | How personal the | Relational/ | Private/ | A loves birthday |
| Warmth | relationship | Personal-enjoys | Professional- | emails; B finds |
| | should feel. | rapport, stories, | wants clear | them awkward or |
| | | personal life talk | boundaries, no | invasive. |
| | | | small talk | |
| 3. Scope of | How much | Detail-Oriented- | Big-Picture- | A wants “how it |
| Detail | information they | likes granular | prefers | works”; B wants |
| | want. | explanations. | summarized | “are we on track?” |
| | | | insights. | |
| 4. Recognition | How they feel | Symbolic- | Substantive- | A lights up at a |
| Style | valued and | appreciates | values progress, | handwritten note; |
| | appreciated. | gestures, gifts, | savings, or | B wants a tax |
| | | cards | performance | projection |
| | | | proof | |
| 5. Engagement | How often they | High Touch- | Low Touch- | A expects |
| Frequency | want contact or | wants regular | prefers minimal | monthly updates; |
| | check-ins. | proactive | contact, only | B just wants |
| | | outreach | when needed | quarterly silence |

| Dimension | What It Captures | Pole A | Pole B |
|---|---|---|---|
| B. Decision | How they make | Collaborative- | Directive-wants |
| Style | choices. | wants to | the planner to |
| | | discuss and | decide and |
| | | co-decide | summarize |

In some embodiments, the above relational style framework may be used to infer preferences of an individual and/or group, including employee, client, and/or any other person or group along one or more of the above axes. In some embodiments, the individual's (or group's) relational style may be summarized in a three to five word phrase for example (though another word limit may be used), for example, “analytical, results-driven, partner.” The system may then recommend one or more specific gestures or outreach actions that the system user, employer, etc. may do for that person that would feel meaningful given that person's relational style and interests.

For example, a financial planner may use the system of the present disclosure to analyze a client's relational style in order to receive and act upon one or more specific acts that are tailored to the preferences and relational style of that client. In this case, the financial planner may provide the system some number of communications received from the client, which again, in some cases could include a group, such as the client's family and/or the client's family and their accountant and/or attorney for example. The system may be provided with additional information about the client and/or group, including the annual fees paid to the financial planner, birthdays, other known interests and/or information. The system may analyze this information, determine the relational style of the client and/or group, and provide some number of specific actions that are the most important for the financial planner to take relative to the client.

Actions may be determined by the system that will have the most value for example in closing a prospect, kicking a bad prospect out, improving the connection with a client, getting in front of client churn, etc. For example, using current market news, the system may recommend pairing up what clients will be nervous about what and provide the planner a message in the planner's voice/tone to send to each client; the system may recommend ideal ways to reach out for important events, such as birthdays or anniversaries that might happen in the near future, including for example, writing a happy birthday email including known highlights from the last year and upcoming exciting events in the year to come, or making a reservation at the client's favorite restaurant; the system may analyze for churn risk, low sentiment emails, long times since a client last emailed, for example; the system may analyze for the best next message to sent to prospects and when the message should be sent; the system may recommend the ideal time to ask for a referral, and provide an email to send or the words to say in the next meeting.

In some embodiments, each recommendation may be ranked on a scale of importance, for example a scale between 1 to 100, where 1 is the most important. Though it will be understood that any other scale or ranking scheme may be used. The recommendations may be concrete and specific in some embodiments, for example, “send a brief quarterly progress email”; “mail a photo book for their grandkids”; “call to celebrate a milestone.” The system may also include a brief explanation of why the recommendation would be impactful based on the relational style analysis of the client and/or group.

In making recommendations, the system may ignore noise from analyzed data, for example ignoring signatures, disclaimers or generic pleasantries; the system may merge clues intelligently, for example by combing related mentions into coherent facts, for example, “tracking expenses in Quicken”+“wants clarity on spending”=interest: organization in finances; the system may be concise using short bullet-style text with minimum lines per field, for example; the system may avoid speculation by omitting something that is not clear from the data (e.g., emails); the system may use email writing cues such as tone, length, structure, speed, punctuation to infer behavior and preferences; and/or the system may provide a group analysis for two or more people that may be properly joined for analysis.

The system may provide, store, and/or update a individual or family dossier that may be used to provide analysis and/or recommendations, for example. An example dossier may look like the following, in some embodiments.

Dossier: “family_dossier”:{“communication_dynamics”:[“Bob is the primary point of contact but proactively includes Kimmy in important communications and decisions.”,“Prefer a mix of email for quick updates and in-person or virtual meetings for substantive discussions.”,“Value direct and clear communication, appreciate follow-ups.”],“family_name”:“Cianci”,“financial_priorities”:[“Understand and minimize fees.”,“Ensure proper handling of trust-related assets and large transfers (escrow).”,“Explore investment options (IRA reinvestment, loans) and compliance requirements.”],“members”:[“Bob Cianci”,“Kimmy Cianci”],“notable_sentiment_or_behavior”:[“Engaged and actively involved in managing their finances.”,“Appreciative of personal touches (lunch) and professional guidance.”,“Flexible with scheduling but may have work/travel-related conflicts.”,“Open to learning about financial strategies and long-term wealth building.”],“recommended_gesture”:{“action”:“Schedule a joint ‘Annual Review Prep’ session with Bob and Kimmy to discuss their financial goals, progress, and any questions, allowing them to collaborate on strategy.”,“reason”:“The family values collaboration, wants to see progress, and Bob explicitly involved Kimmy in future communications. A joint, goal-focused meeting aligns with their shared relational style traits.”},“shared_goals”:[“Grow wealth and see year-over-year progress.”,“Consolidate financial advisory to a single firm.”,“Joint financial planning and decision-making.”],“shared_interests”:[“Travel (Florida trip mentioned).”,“Social engagement, including business lunches.”]}, “individual_dossiers”:{“Bob Cianci”:{“client_relationaly_style”:{“communication_channel”:“Mix of asynchronous (email for quick updates) and live/conversational (prefers in-person meetings or calls).”,“decision_style”:“Collaborative; asks questions, discusses options, and involves family members in major decisions.”,“engagement_frequency”:“High-touch during critical phases (onboarding, large transfers) and for scheduling, but low-touch for routine updates.”,“recognition_style”:“Substantive (focused on results, progress, and financial clarity) with an appreciation for symbolic gestures like business lunches.”,“relational_warmth”:“Friendly and appreciative, enjoys personal touches like lunch, but keeps communication primarily business-focused.”,“scope_of detail”:“Appreciates specific details (FDIC cert, fees) and asks for clarity, but also focuses on overall progress and goals.”},“communication_traits”:[“Asks concise, pointed questions, often in bullet points or short sentences.”,“Proactive in scheduling meetings and prefers to meet at his office.”,“Includes his wife in important financial discussions and email chains.”,“Responds relatively quickly to scheduling requests and confirmations.”],“financial_concerns”:[“Clarifying trust listings and FDIC insurance specifics.”,“Understanding reinvestment strategies for cash and IRA loan possibilities.”,“Compliance with union rules for payments and minimizing fees.”,“Managing significant transfers like escrow accounts.”],“interests”:[“Business operations (Metal Mechanics Inc., year-end financials).”,“Socializing over lunch (e.g., ‘Tree guys for Lunch’).”,“Travel.”],“overall_relatioanal_style_summary”:“Direct, results-oriented, collaborative, appreciated.”,“recommended_gesture”:{“action”:“Provide a concise, executive summary of his SEP transfer progress and key investment allocations, highlighting the ‘fees’ section if relevant.”,“reason”:“Bob is results-oriented and detail-focused when it comes to financial specifics (e.g., ‘highlighted the fees’). A clear, substantive summary of progress and cost transparency aligns with his recognition and detail preferences.”},“relationship”:“Primary Client/Head of Family”,“tone_summary”:“Direct, professional, appreciative, occasionally brief.”},“Kimmy Cianci”:{“client love language”:{“communication_channel”:“Primarily asynchronous (email for updates) as added by Bob, but likely prefers live/conversational for joint decision-making with Bob.”,“decision_style”:“Collaborative, especially in conjunction with Bob.”,“engagement_frequency”:“Low-touch for direct communication, high-touch when included in joint family discussions.”,“recognition_style”:“Likely values progress and clear understanding of joint financial goals.”,“relational_warmth”:“Likely values a friendly, personal approach, given Bob's appreciative nature and inclusion of her.”,“scope_of_detail”:“Appears to engage in big-picture planning (wealth growth) with Bob, specifics handled by him.”},“communication_traits”:[“Less direct communication via email, primarily added to threads by Bob.”,“Participates in joint decision-making (e.g., ‘Kimmy and I are going to Florida tomorrow night. We'll discuss the above’).”],“financial_concerns”:[“Setting up a new individual account.”,“Participating in discussions about family wealth growth.”],“interests”:[“Joint family planning and financial discussions.”,“Travel (e.g., Florida trip).”],“overall_love_language_summary”:“Collaborative, included, growth-focused partner.”,“recommended_gesture”:{“action”:“Send a personalized welcome email to Kimmy after her account setup, reiterating appreciation for their trust and briefly outlining how she can access information or contact the team.”,“reason”:“Kimmy is being brought into the formal client relationship by Bob, so a direct, warm welcome confirms her inclusion and establishes a personal connection, aligning with a desire for relational warmth and recognition.”},“relationship”:“Spouse/Joint Client”,“tone_summary”:“Engaged, collaborative, likely aligns with Bob's communication style.” household_name.

The system may include leveraging the insight into the client's relational style by recommending actions based on current news. For example: for news related to the TCJA Income Tax “Sunset” Cliff, the system may provide the Headline: Legislative gridlock in Washington has left the extension of the Tax Cuts and Jobs Act (TCJA) individual income tax provisions unresolved, with rates set to revert (e.g., 37% to 39.6%) on December 31. The system may identify the client profile this information may be relevant to: high earners & mass affluent (Income >$200 k/year). The system may then provide the following script to the planner to use with appropriate and identified clients: “Given the legislative stalemate, we must execute our ‘accelerate and convert’ strategy now—pulling 2026 bonuses into 2025 and maximizing Roth conversions before tax rates potentially spike on January 1st.” It will be understood that embodiments using the relational style analysis described may be used instead or in addition to other embodiments described herein.

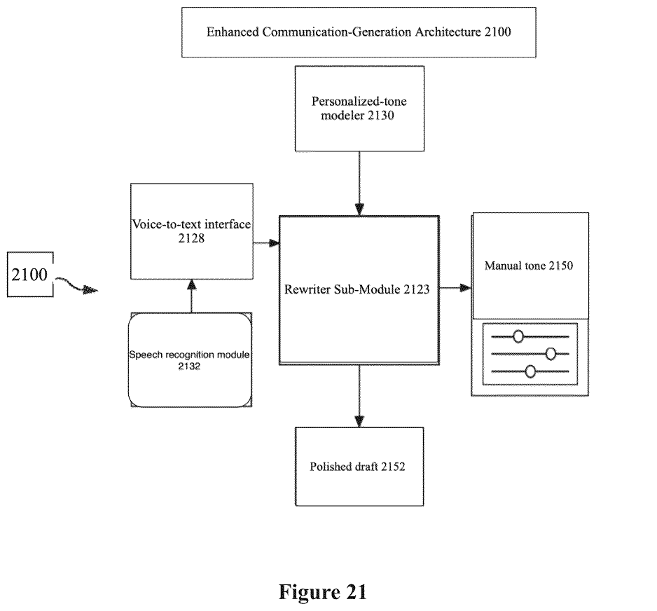

FIG. 21 shows enhanced communication-generation architecture 2100 within improved response-generation engine 340 (see FIG. 3). In some embodiments, the architecture incorporates rewriter sub-module 2123 that augments AI engine 346 and NLP engine 348 by combining voice-to-text input 2128 that may convert spoken dictation into draft text that may include a personalized-tone modeler 2130 that adapts the draft to the sender's stylistic fingerprint and the recipient's profile supplied by style-identification engine 330. It will be understood that other embodiments may employ different speech-recognition services, input modalities, or style-adaptation techniques without departing from the present disclosure.

In some embodiments, the voice-to-text input mechanism 2128 may be operatively linked to the rewriter module 1612 and may allow users to dictate message content via microphone or voice-enabled interface. Speech data may be converted into text using a speech recognition engine 2132, which may include pre-processing to identify filler language, pauses, and/or transcription ambiguities, for example. Once transcribed, the text may be passed to a large language model (LLM)-powered generator that may output a rewritten version optimized for clarity, grammar, and intent. In some embodiments, the voice-to-text input and rewriter functions may be executed in tandem, such that spoken content may be directly transformed into a polished draft 2152 within a single workflow, though other or different processing pipelines may be utilized in alternative embodiments.

To ensure the output reflects user-specific communication patterns, the system may employ atone modeling engine 2130 that may construct and maintain atone profile for each user. This profile may be based on historical writing samples and may quantify stylistic elements such as formality, brevity, use of passive voice, emotional tone, and/or domain-specific terminology, for example. The tone modeling engine 2130 may allow the rewriter module 1612 to generate revised drafts that mirror the user's preferred style. For example, a user who frequently writes in a highly formal and concise manner may receive system-generated drafts that maintain those same attributes. It will be understood that alternative or additional user-style modeling approaches may be employed in other embodiments.

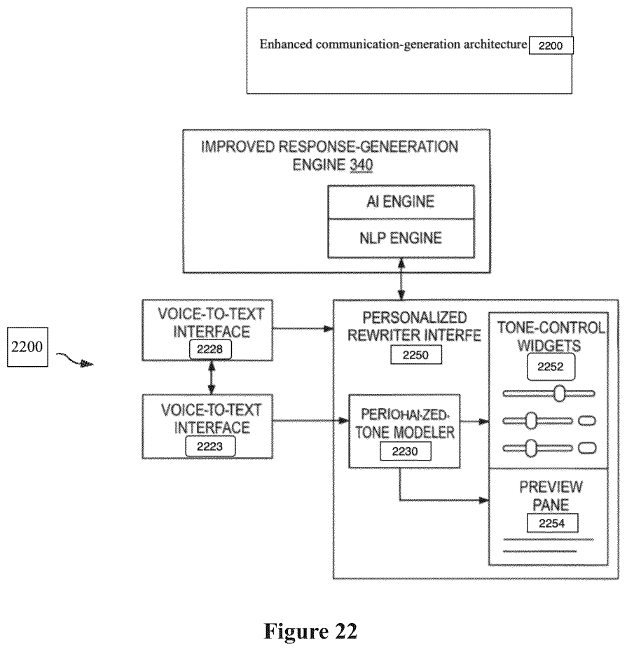

FIG. 22 shows enhanced communication-generation architecture 2200, in which a personalized rewriter interface 2250 appears on the same dashboard that hosts rewriter sub-module 2223. The interface includes interactive tone-control widgets 2252 (sliders, toggles, or preset buttons) that let a user fine-tune parameters such as assertiveness, warmth, optimism, and/or clarity, for example. Adjustments made with controls 2252 may be stored in the user's profile in database 342, and rewriter sub-module 2223 may instantly regenerate the draft with the updated tone characteristics, in some embodiments. A side-by-side preview pane 2254 displays multiple tone variants so the user can select a preferred version before finalizing or sending the communication, while alternative layouts, visual indicators, or selection mechanisms may be employed in other embodiments without departing from the present disclosure.

In some embodiments the rewriter sub-module 2223 of the improved response-generation engine 340 may be accessible through desktop- and mobile-optimized access modalities, including a web-based dashboard that mirrors the sidebar controls available in client-specific add-ins such as the Microsoft Outlook extension; alternative embodiments may provide the same functionality through native mobile apps, browser extensions, and/or voice-assistant integrations, for example without departing from the present disclosure.

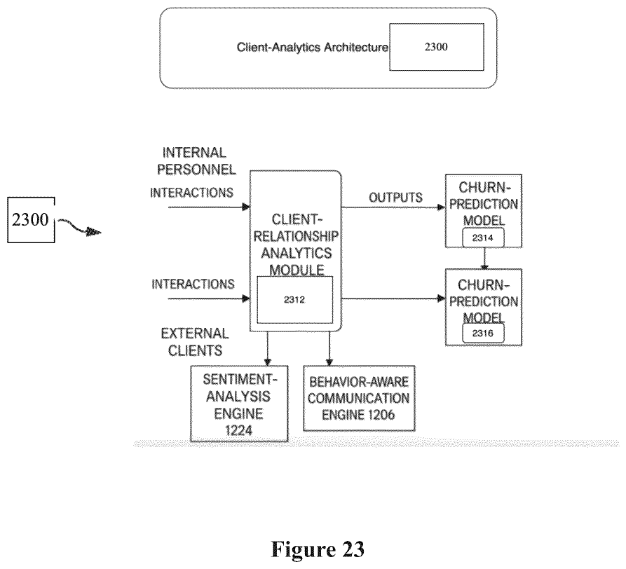

FIG. 23 shows client-analytics architecture 2300, within which client-based analytics module 2312 may save, store, monitor, and/or evaluate communications between internal personnel and external clients to assess relationship health and predict risk indicators such as client-churn 2314 (i.e., the likelihood that a client will terminate or suspend the relationship). In some embodiments, the module may leverage the same sentiment-analysis and/or behavioral-profiling engine used for internal communications, but may apply them specifically to external traffic-including email, chat, video transcripts, CRM entries, and/or other interaction records-without departing from the scope of the present disclosure.

FIG. 3 illustrates Sentiment Analysis Engine 332, previously described above, which employs natural-language-processing techniques and large-language-model inference to assign a normalized sentiment score to each client-originated or client-directed communication on a scale from −1.0 (strongly negative) to +1.0 (strongly positive). Alternative scoring scales, normalization methods, or sentiment-classification schemes may be used in other embodiments. Consistent with the earlier description, aggregated sentiment scores may be tracked by client account, communication thread, or sender/recipient pair and monitored over time to reveal engagement trends and directional shifts in tone.

In addition to sentiment scoring, the system may include a churn risk detection engine that may evaluate behavioral and linguistic indicators associated with disengagement or dissatisfaction on the part of the client. These indicators may include patterns such as reduced message length, increased response delay, use of passive or emotionally distant language, and/or frequency of negative sentiment terms, though it will be understood that additional or alternative disengagement indicators may be incorporated in other embodiments. When churn indicators exceed a configurable risk threshold—either individually or in combination—the system may trigger a churn risk alert to one or more designated members of the company.

Alerts may be provided through a user-specific, or executive or client success dashboard and in some embodiments the alerts may be color-coded based on severity level (e.g., red for high risk, yellow for moderate, green for low). Alternative visualization styles, alert formats, or severity labels may be employed in other embodiments. Each alert may include contextual information such as what the specific risk(s) are, the affected client account, the internal members working with the client, flagged messages, and/or recommended follow-up actions, for example. The dashboard also may include filtering capabilities that allow users to view results by client name, account group, communication channel, flag category (e.g., sentiment drop, delay anomaly), and/or individual team member, for example.

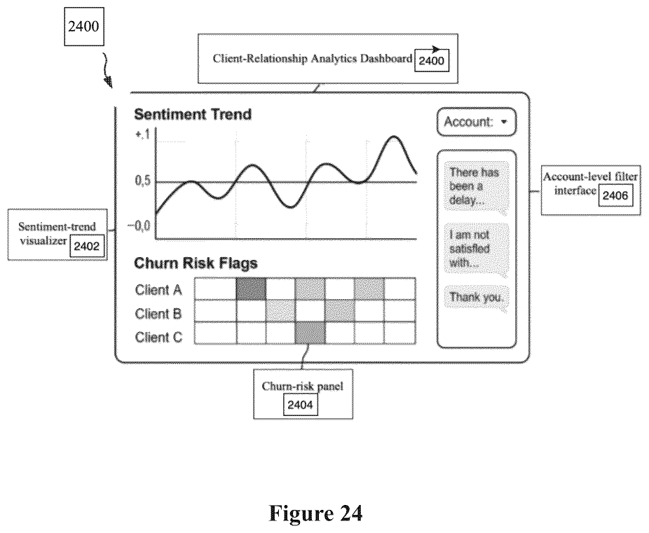

In one embodiment, client-analytics dashboard may provide a suite of reports—time-series graphs of sentiment scores, heat-maps of flagged-risk interactions, and/or drill-down views of the specific messages that raised each alert, for example, such that sales and account teams can intervene early to preserve revenue and improve satisfaction. FIG. 24 shows client-relationship analytics dashboard 2400: a sentiment-trend visualizer 2402 may plot the composite sentiment for a selected account over user-defined intervals; a churn-risk panel 2404 may list clients whose risk score has crossed the configurable threshold and show the interactions that drove the spike; and an account-level filter interface 2406 may allow the user pivot the entire view to any target client or segment, thereby tying each visual indicator directly to the underlying communications and recommended follow-up actions.

In some embodiments, the system may include an analysis of, for example, chum risk and provide a knowledge graph presentation of the analysis. The knowledge graph may be a directed graph network of communications mapped from text space to 2-D construction, for example, as may be seen in FIG. 31. In one embodiment, the graph may include nodes that are displacing outwards and are thus indicative of higher churn probability when the distance from the central node exceeds a certain threshold. In another embodiment, the graph may, or may also, identify nodes that are displacing inwards and are thus indicative of a referral scenario when the distance from the central node shows a decreasing trend, for example. In still another embodiment, the graph may, or may also, identify nodes that are stable outwards and are thus indicative of non-starters when the distance from the central node remains above bounds, for example. In another embodiment, the graph may, or may also, identify nodes that are stable inwards and are thus indicative of a higher closure probability when the distance from the central node remains within bounds. In still another embodiment, a series of temporal graphs my allow for describing an evolving persona of one or more of the previously mentioned embodiments via a predicted model including but not limited to graph transformer networks (GTNs) for example, and that may derive the following information, in some embodiments: 1) graph awareness to estimate both local and global attention along with long-range dependencies between nodes, not just immediate neighbors, for example; 2) edge intelligence to estimate chemistry or entity relationships, for example, and/or 3) opinion dynamics via aspect-based sentiment analysis (ABSA) and sentiment propagation. It will be understood that still other embodiments are possible including other forms of presenting the knowledge graph information, and/or including additional and/or different information to be predicted and/or presented.

In some embodiments, the text space to 2-D construction may be based on the following logic, though it will be understood that other logic is possible: 1. Tag non-stop words in the source file based on part of speech (PoS), where any noun may be defaulted to a node, and adjectives and verbs may contribute to edge formulation alone; 2. the number of interactions between nodes enables edge weight formulation, where an edge is only formed when at least one communication occurs, and if the communication is indirect, then a low weighted edge may be formed. Embodiments of the knowledge graphs may include and/or be based on the following, in some cases.

| | Degree | Betweeness | Eigenvector | Closeness | Katz |
|---|---|---|---|---|---|
| Measure | Centrality | Centrality | Centrality | Centrality | Centrality |
| Definition | Number of | Number of times | A messure that | Average | Combination |
| | direct | a node lies on the | is proportional | distance to | of degree |
| | connections a | shortest path | to the sum of | other nodes | and path- |
| | node has | between any | the centralities | | based |
| | | other two nodes | of the nodes | | centrality |
| | | | that a node is | | |
| | | | connected to | | |
| Use in the | To find the | To find the best | To find the most | To find the best | To find |
| graph | most | entity that | Influential entity | entity to spread | entities thet |
| | connected | controls | (who knows | information | are aware |
| | entity | information flow | other influential | quickly and | but |
| | | | entities) | vastly | indifferent |
| Role/Persona | Point of | Bridge, disruptor | Influencer | Champion or | Supporter |
| | contact or trust | or bottleneck | | communicator | |
| | builder | | | | |

In some embodiments, edge construction may be performed as follows:

$${( Edge Weight )}_{i} = \frac{1}{5} [ \frac{( Positive Polarity - Negative Polarity )}{2} + Normalized Response Time + Normalized Hops Created + Normalized Number of Channels Added + Normalized Number of Flags Added ]$$

Thus, according to various embodiments, a knowledge graph of the present disclosure may include the following steps: converting a conversation to a graph; establishing nodes and edges; assigning edge weights based on the mathematical condition described above; measuring centralities and assigning personas; establishing routing information and bottlenecks; deriving temporal statistics; and/or establishing evolution and stability. It will be understood that additional, fewer, and/or different steps may be included in different embodiments of the present disclosure.

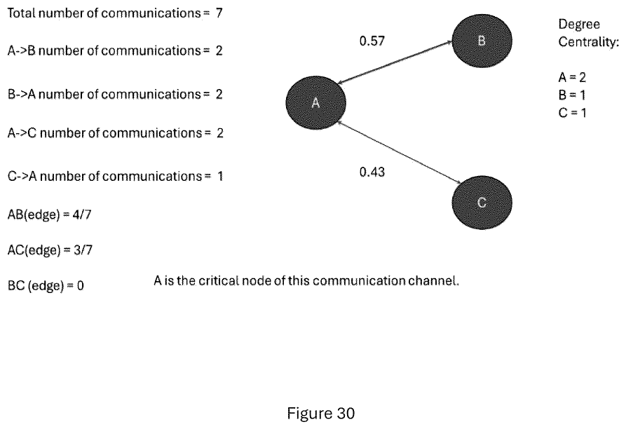

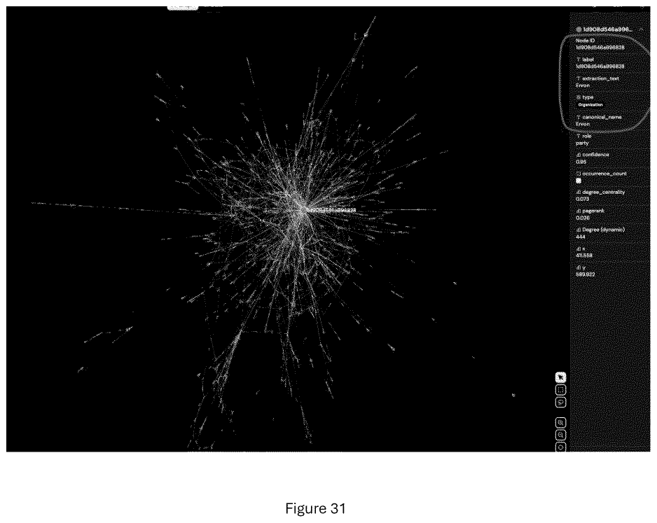

For example, as shown in FIG. 30, an illustrative embodiment is provided, whereby A asks B for help on pricing after which A completes a purchase order and sends to C for ordering. C responds to A seeking clarification of a price which A forwards to B. B responds with the clarification, which A sends to C. As may be seen there are a total of seven communications in this example: two from A to B; two from B to A; two from A to C; and one from C to A. According to the above algorithm, and as shown, A is the critical node of this communication channel.

In some embodiments, the system may include a behavioral-feedback and gamification module—where “gamification” refers to the introduction of game-style elements such as points, badges, leaderboards, or achievement levels that reward desirable actions-to reinforce communication practices through, for example, real-time scoring, nudging, and/or goal-based interaction metrics. The module may be operatively coupled to the system's rewriter engine, sentiment-analysis engine, behavioral-profiling engine, and/or other agents, and may compute and display a communication-effectiveness score for each authored message prior to sending.

The communication effectiveness score may be based on a combination of factors including alignment with the recipient's behavioral style, tone appropriateness, sentiment balance, and/or grammatical quality, for example. In certain embodiments, each message may be assigned a numerical score ranging from 0 to 100, where higher scores reflect stronger alignment with organizational communication best practices, although other or different scoring ranges or grading schemes may be employed in other embodiments. The system may further include scoring breakdowns by one or more sub-metrics, for example, but not limited to “clarity,” “emotional appropriateness,” and/or “tone-fit,” for example, and may provide visual indicators or badge-based feedback to reinforce improvement over time.

The gamification module may further include historical performance tracking, allowing users to view score trends over time. In some embodiments, user-specific or team-based score dashboards may display aggregated weekly or monthly communication scores, highlight improvements, and/or suggest areas for focus, for example. In some embodiments, designated company personnel, such as for example, managers may receive anonymized or de-identified summaries of communication performance across teams or any other basis, which may allow for targeted coaching based on behavioral trends and/or other targeted action.

In some embodiments, the system may include a multilingual rewriting module that may analyze and generate communications in multiple languages. The multilingual module may be operatively coupled to the rewriter engine and provide language appropriate sentiment, tone, and/or style adjustment and may include culturally specific sentiment, tone and/or style adjustment recommendations based on language selection and/or geographic specification. In some embodiments, input messages authored in a first language may be rewritten in either the same language or a different target language while preserving drafter tone characteristics and recipient alignment.

The multilingual module may include a language detection component that may identify and/or automatically identify the language of incoming or authored content. Detected language information may be passed to a multilingual transformer-based engine that may be fine-tuned for cross-linguistic style preservation, in some embodiments. For example, a message originally authored in Spanish may be rewritten in English with retention of the sender's intended emotional tone and level of formality. Likewise, messages written in English may be adjusted for stylistic norms of a French-speaking or Japanese-speaking recipient, for example, while it will be understood that any other language and/or combination of languages may be used in the system according to other embodiments.

In one embodiment, the system may maintain tone profiles for users in multiple languages, with the ability to store parallel stylistic attributes for cross-language output. Users may select their preferred output language through the user interface, or the system may auto-select based on recipient metadata.

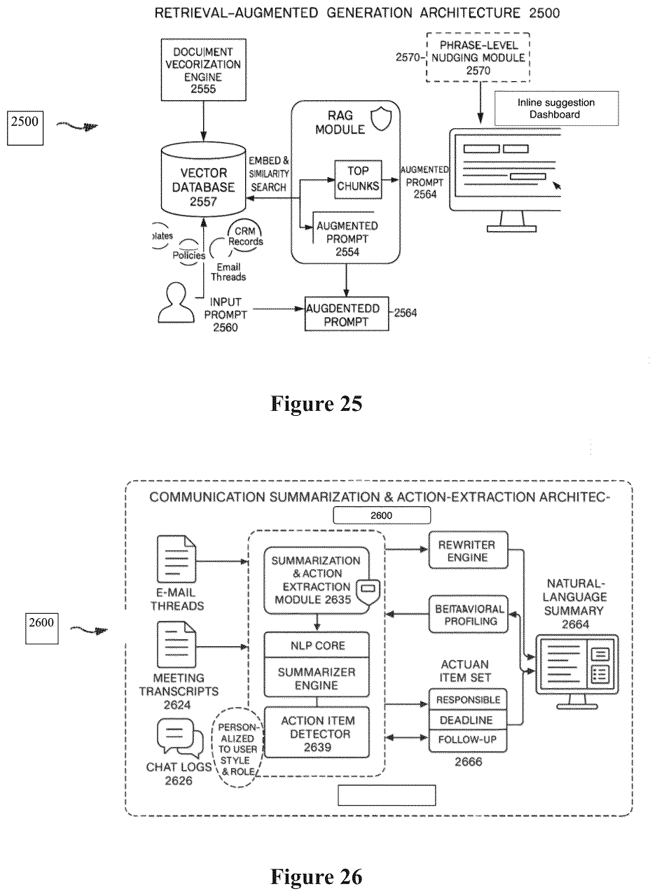

FIG. 25 shows retrieval-augmented generation architecture 2500, where RAG module 2553 may personalize communication outputs by drawing on contextual enterprise data such as company documents, templates, CRM records, and/or prior email threads, for example. The module may be operatively linked to document-vectorization engine 2555 and a local or cloud-hosted vector database 2557 that parses enterprise sources into semantic chunks for indexed retrieval, in some embodiments.

When a user enters an input prompt 2560—for example, “Draft a concise thank-you email to Acme Corp acknowledging its new purchase order”—the request may be routed to the RAG module 2553. The module may embed the prompt, perform a similarity search against the semantic vectors stored in vector database 2557, and retrieve the top document chunks 2562 (e.g., an approved thank-you template plus the purchase-order details). The module may concatenate those chunks with the original prompt to form an augmented prompt 2564, which may be forwarded to the large-language model 2566. The model may then generate a context-aware draft 2568 that returns to the user interface for review or immediate sending.

The RAG module 2553 may incorporate a permissions layer 2559 that limits retrieval to documents the requesting user is authorized to see-based on role, department, or other organization-defined rules. The user in some embodiments may supply a natural-language prompt through the interface, while contextual inputs such as product specification sheets, compliance policies, customer-support logs, and/or team knowledge bases, for example may be automatically pulled from vector database 2557. The resulting draft may therefore align with the desired tone and behavioral style and may also embed up-to-date information the user is permitted to access.

In some embodiments, a phrase-level nudging feature highlights particular segments of a user's draft and, via the user-accessible dashboard, presents suggested edits for each highlighted phrase. Unlike full-message rewrites provided by the system, the phrase-level nudging module may operate at the sub-sentence level or provide phrase level granularity for example, and/or may be integrated with the system's behavioral alignment and/or tone analysis engines, for example. Upon detecting a localized misalignment, such as a phrase that diverges from the recipient's known communication preferences or violates organizational tone guidelines, the system may highlight the phrase and present one or more contextually appropriate alternatives.

One or more of the suggested segment replacements may be accompanied by a brief rationale, for example, “Consider a more collaborative tone here,” which may be interactively accepted or ignored by the user. In one embodiment, the nudging interface may include real-time feedback with inline edit options for example, enabling low-friction behavioral refinement during the composition process. Phrase-level nudging may be particularly effective in scenarios where full-message rewrites are unnecessary or undesirable, such as when maintaining legal or contractual language is necessary.

FIG. 26 shows summarization and action-extraction module 2600, which analyzes long-form digital communications—such as email threads, meeting transcripts, and the like—and can generate one or more structured summaries including action-oriented insights according to some embodiments. Summarization and action-extraction module 2635 may be operatively coupled to rewriter engine 2640, behavioral-profiling agent 2642, and/or any other agent, module, or engine to produce personalized summaries that reflect the communication style and role of the user.

In some embodiments, the summarization and action-extraction module 2662 may generate a plurality of outputs, including but not limited to: (i) a natural-language summary 2664 of the communication content—optimized for brevity, clarity, and/or other desired parameters—and/or (ii) a set of extracted action items 2666, optionally tagged with responsible parties, deadlines, follow-up categories, and/or other desired options. Action-item extraction may leverage, for example, named-entity recognition, temporal-phrase detection, and/or speaker-attribution models; however, additional or alternative output types or metadata may be provided in other embodiments. In some embodiments, action items 2666 or other outputs may be displayed in a sidebar or dashboard view 2680 alongside the original message, allowing the user to quickly review or forward task summaries.

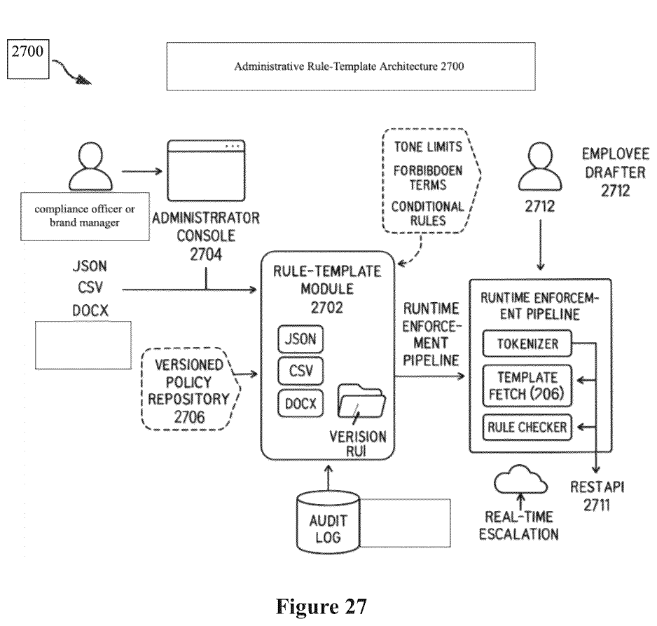

FIG. 27 shows administrative rule-template architecture 2700, which exposes a browser-based administrator console 2704. Through console 2704 a compliance officer or brand manager may upload structured template files—e.g., JSON, CSV, or DOCX—or complete a form that captures: (i) required boiler-plate phrases (e.g., “This message may contain confidential information,”); (ii) tone ceilings and floors (such as maximum assertiveness level); (iii) forbidden words or expressions; and/or (iv) conditional rules triggered by recipient, department, or jurisdiction, for example. Each upload may be parsed, assigned a unique version ID, and/or stored in a versioned policy repository 2706 that indexes templates by department, effective date, and/or revision history, for example, while older versions remain queryable for audit purposes but are marked inactive once superseded in some embodiments.

When any employee drafter 2712 composes a message in an integrated client—such as the Outlook add-in 2714—the draft text streams in real time to a runtime enforcement pipeline 2708 in some embodiments. Pipeline 2708 may tokenize the draft, fetche the active template set for the drafter's department from repository 2706, and call both the rewriter engine 340 and the red-flag detection engine 1810 to evaluate every sentence against the applicable required-phrase list, tone bounds, and forbidden-language rules, for example. If a rule is breached, the system may inject an inline banner 2716 that explains the violation and displays a rewrite suggestion 2718 generated by the rewriter engine 340 for example; depending on policy, the user may (a) accept the fix, (b) edit manually until the banner clears, or (c) override with justification according to some embodiments. All outcomes—including rule ID, user action, timestamp, and before/after text hash—may be persisted to an audit log 2710, in some embodiments. Audit records may be exposable via a REST API 2711 for downstream HR, legal, or compliance systems, enabling periodic reporting or real-time escalation of repeated infractions. Once the draft passes all active checks, pipeline 2708 may return a “compliant” flag to the client, and the user may send the message without further interruption, according to some embodiments.

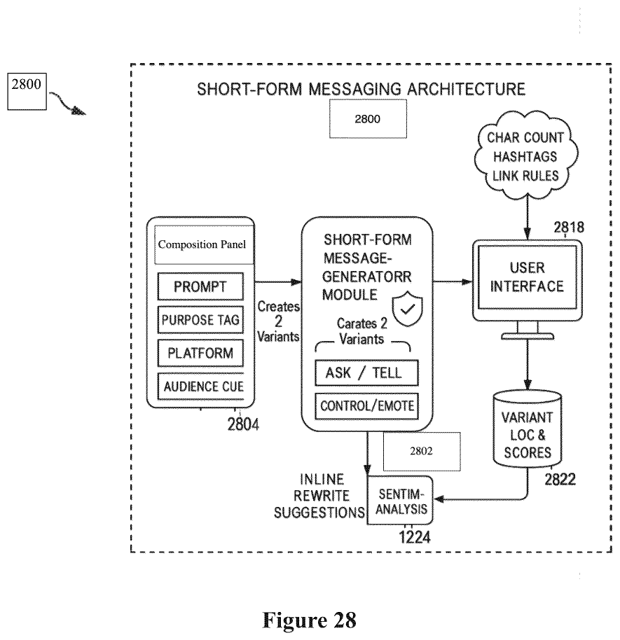

FIG. 28 shows short-form-messaging architecture 2800, where a user at composition panel 2804 might type the prompt “Announce our new AI feature,” tag the purpose as promotional, pick LinkedIn as the platform, and add an audience cue such as “enterprise CTO,” for example. In some embodiments, the selected inputs may be fed into short-form message-generator module 2802, which may consult platform rules for character count, hashtag syntax, and/or link policy, for example, apply the Ask/Tell and Control/Emote alignment logic, and return two candidate variants—one a 120-character LinkedIn post with #AI and #Innovation hashtags, the other a more conversational Slack blurb with an inline link.

In some embodiments, the variants may flow to user interface 2818, where live platform-rule bubbles, for example, may display active constraints, then pass through sentiment-analysis engine 1224 for tone screening that can flag phrases like “game-changing” as overhyped and offer inline rewrites, after which each version along with its behavioral-alignment score and sentiment score may be stored in variant log 2822 so the user can preview, edit, schedule, and/or immediately send the chosen post while the system/or records performance data for future A/B optimization across LinkedIn, X, Slack, Microsoft Teams, and other channels, according to some embodiments.

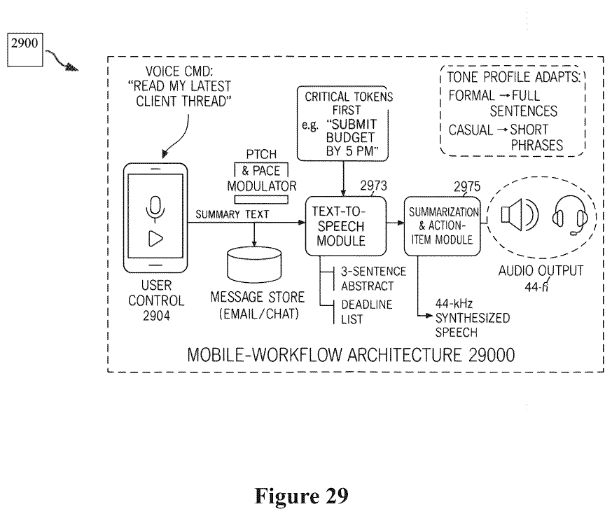

FIG. 29 shows mobile-workflow architecture 2900, where a mobile user at user control 2904 may give a voice command such as “Read my latest client thread” or tap a “play” icon, causing text-to-speech module 2973 to pull the chosen messages, send them to summarization-and-action-item module 2975 for a three-sentence abstract plus a deadline list, then synthesize that summary into 44 kHz speech and stream it through the handset speaker or Bluetooth headset, for example.

Module 2973 may modulate pitch, pace, and vocabulary to match the user's tone profile so a formal-profile user hears complete sentences with courteous closings while a casual-profile user hears shorter phrases, and it prioritizes critical tokens by moving items like “Submit budget by 5 PM” to the start of the audio and inserting a pause before secondary details.

When the same user drafts a reply, the composition panel may pass a prompt such as “Write a concise task-oriented response for Alex, whose traits are direct, task-oriented, fact-focused, organized, and concise” to the improved response-generation engine; the engine may embed those traits, produces two candidate messages, sends them through the previously disclosed Ask/Tell and Control/Emote evaluator for alignment scoring and the sentiment-analysis engine 1224 for tone checking, then returns the top-scoring draft for user approval or further editing.

By way of illustration, assume a user has drafted the following preliminary email: “Solidifying DW integration timeline, we may need to push 1-2 weeks, we need to push because we believe our estimates of the time to go through DriveWealth's certification program to get production keys to be too aggressive, so we want to extend our timeline to what we think has the highest probability of actually happening. And if there is a clear pattern for how DW account numbers are created, we can accurately guess what they will be now and use them on our ACAT forms. If there isn't a clear pattern, we will have to wait until post-certification, and then we'll create the accounts, get the actual DW account numbers, put them on our ACAT transfer forms, and then send the DocuSign forms to clients.” Because the intended recipient's profile is direct, task-oriented, fact-focused, organized, and concise, the author invokes the system's phrase-level alignment check with the prompt: “Point out every phrase or sentence that does not line up with my colleague's communication traits.”

In this example, the phrase-level alignment component returns a structured list of text spans that diverge from the recipient's direct, task-oriented, fact-focused, organized, and concise profile, along with system-generated improvements. First, it highlights the opening clause “Solidifying DW integration timeline, we may need to push 1-2 weeks,” noting that the wording is indirect and verbose; the system proposes the succinct alternative “We need to push the DW integration timeline by 1-2 weeks.” Next, it flags “We believe our estimates of the time to go through DriveWealth's certification program to get production keys to be too aggressive,” explaining that the statement lacks concrete data and therefore violates the fact-oriented requirement. The component supplies a data-backed rewrite such as “Our initial timeline assumed DriveWealth would process our certification within two weeks, but their current estimate is four weeks.”

The alignment engine also flags the clause “And if there is a clear pattern for how DW account numbers are created, we can accurately guess what they will be now,” noting that the wording is circuitous and therefore fails the recipient's concision criterion. It proposes the streamlined substitute: “If we can identify a clear pattern for how DW account numbers are created, we can estimate the account numbers now.”

After the edits are applied, the system presents this recipient-aligned draft: “We need to push the DW integration timeline by 1-2 weeks. Our earlier estimates for DriveWealth's certification were too aggressive. If a consistent pattern exists for DW account numbers, we can generate provisional numbers now; otherwise, we will wait until post-certification to create the accounts, obtain the actual numbers, and update the ACAT forms.”

This refined draft aligns with the recipient's direct, task-focused, data-driven style because it states the timeline change plainly, cites concrete reasons for the delay, and outlines clear next steps in a compact structure, making the message more likely to be understood and appreciated.

When the system lacks sufficient prior emails for a recipient, it can draw writing samples from sources such as LinkedIn or other public platforms, analyze those samples, and infer the recipient's dominant communication traits.

The style-identification engine can run this profiling during initial setup by scanning available historical messages or on demand as soon as the author adds a new recipient, ensuring a relevant communication profile is always ready before the message is finalized.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of scope of the invention, and what is intended by the applicants to be the scope of the invention, is the literal and equivalent scope of the set of claims that issue from this application, in the specific form in which such claims issue, including any subsequent correction.

1.-20. (canceled)

21. A computer-implemented method of providing improved electronic communication and internal electronic communication insights, comprising:
receiving a plurality of sample electronic communications for a would-be-sender or an aggregate group of would-be-senders or recipients;
analyzing the plurality of sample electronic communications;
providing internal communication insights to one or more authorized users based on the analyzed plurality of sample electronic communications; and
displaying the internal communication insights on at least one interactable dashboard interface.

22. The method of claim 21, wherein the step of providing internal communication insights comprises providing a sentiment analysis engine, wherein the sentiment analysis engine includes:
reviewing the plurality of sample communications for the would-be-sender or the aggregate group of would-be-senders or recipients;
generating an insight report related to the analyzed communications; and
providing the insight report to the one or more authorized users via the at least one interactable dashboard interface.

23. The method of claim 22, wherein the insight report includes evaluating the received and analyzed electronic communication from a would-be-sender or the aggregate of would-be-senders or recipient on a rating sentiment scale or sentiment score.

24. The method of claim 23, wherein the sentiment scale or sentiment score is based on individual electronic communications for the would-be-sender or as the aggregate group of electronic communications from two or more would-be-senders or recipients.

25. The method of 23, wherein the step of providing internal communication insights comprises providing the insight report as a generated heatmap for view by the one or more authorized users, via the at least one interactable dashboard interface.

26. The method of 23, comprising tracking changes in the sentiment scale or the sentiment score over a selected or predetermined period of time, via a time-series analysis module.

27. The method of claim 26, comprising detecting anomalies, by the time-series analysis module, in the sentiment scale or the sentiment score by comparing a current sentiment trajectory to a historical baseline of the would-be-sender or the aggregate group of would-be senders or recipients.

28. The method claim 21, wherein the step of providing internal communication insights comprises a behavior aware communication engine, wherein the behavior-aware communication engine includes:
reviewing the plurality of sample communications for the would-be-sender or the aggregate group of would-be-senders or recipients; and
analyzing the communications to reveal interaction patterns or detect conversational anomalies of the would-be-sender or the aggregate group of would-be-senders or recipients.

29. The method of claim 28, comprising forwarding, by the behavior-aware communication engine, any detected conversational anomaly data to a miscommunication-risk module for further processing, wherein the miscommunication-risk module contributes pairwise risk metrics, based on the detected conversational anomalies data; and
prompt the one or more authorized users for attention or an intervention with the would-be-sender or the aggregate group of would-be senders or recipients, via the at least one interactable dashboard interface.

30. The method of claim 28, wherein a red-flag scanning module is in operable communication to at least the behavior-aware communication engine in which the red-flag scanning module is configured to identify undesirable communication behaviors within the received plurality of digital communications of would-be-sender or the aggregate group of would-be-senders or recipients.

31. The method of claim 30, wherein an alert is automatically forwarded to the one or more authorized users based on identified undesirable communications identified.

32. The method of claim 21, wherein the step of providing internal communication insights comprises providing a sentiment analysis engine and a behavior-aware communications engine, wherein the sentiment analysis engine includes:
reviewing the plurality of sample communications for the would-be-sender or the aggregate group of would-be-senders or recipients;
generating an insight report related to the analyzed communications; and
providing the insight report to the one or more authorized users via the at least one interactable dashboard interface;
and wherein the behavior-aware communication engine includes:
reviewing the plurality of sample communications for the would-be-sender or the aggregate group of would-be-senders or recipients; and
analyzing the communications to reveal interaction patterns or detect conversational anomalies of the would-be-sender or the aggregate group of would-be-senders or recipients.

33. A computer-implemented system for providing improved electronic communication and internal electronic communication insights, comprising:
a database to store a plurality of sample communications from at least one user:
at least one of a sentiment analysis engine or a behavior-aware communications engine communicably coupled to the database to receive, as input data, at least a sample of the sample communications from the at least one user;
at least one of the sentiment analysis engine or the behavior-aware communications engine configured to analyze the input data; and
an interactable dashboard interface communicatively coupled to the at least one of the sentiment analysis engine or the behavior-aware communications engine, wherein at least one internal communication insight output is provided to one or more authorized users based on the analyzed input data.

34. The system of claim 33, wherein the sentiment analysis engine is configured to:
analyze the input data;
generate an insight report based on the analyzed input data; and
provide, as an output, the insight report to the one or more authorized users.

35. The system of claim 34, wherein the insight report includes one or more sentiment scores or sentiment ratings of the sample of the sample communication from the at least one user.

36. The system of claim 35, further comprising a time-series analysis module that is communicably coupled to at least the sentiment analysis engine, wherein the time-series analysis module is configured to:
track changes in the one or more sentiment scores or ratings over a selected or predetermined period of time; and
detect anomalies in the one or more sentiment scores or ratings by comparing a current sentiment trajectory to a historical baseline of the at least one user.

37. The system of claim 33, wherein the input data is analyzed by the behavior-aware communication engine to reveal interaction patterns or detect conversational anomalies in the electronic communications, as output, of the at least one user.

38. The system of claim 37, where the behavior-aware communication engine is further configured to forward any detected conversation anomaly data to a miscommunication-risk module, communicatively coupled to at least the behavior-aware communication engine, for further processing,
wherein the further processing includes contributing pairwise risk metrics, based on the detected conversational anomalies data; and
the miscommunication risk-module further configured to provide the one or more authorized users a prompt, via one or more dashboard interfaces, for attention or a user intervention.

39. The system of claim 37, wherein a red-flag scanning module is in operable communication to at least the behavior-aware communication engine in which the red-flag scanning module is configured to identify, from the input data, undesirable communication behaviors within the received sample of the plurality of sample digital communications of the at least one user.

40. The system of claim 39, wherein the red-flag scanning module is further configured to automatically forward an alert to the one or more authorized users based on identified undesirable communications found in the input data.
